(19) United States
(12) Patent Application Publication
(10) Pub. No.: US 2024/0339234 A1
(43) Pub. Date: Oct. 10, 2024

(54) RADIONUCLIDE GENERATOR

(71) Applicant: ARTBIO, Inc., Cambridge, MA (US)

(72) Inventors: Sindre Petter Hassfjell, Bekkestua (NO); Tanja Aarvak, Oslo (NO); Gjermund Fjeld Olsen, Fjerdingby (NO); Peter Maurice Wilson, Cambridge (GB)

(73) Assignee: ARTBIO, Inc., Cambridge, MA (US)

(21) Appl. No.: 18/630,522

(22) Filed: Apr. 9, 2024

Related U.S. Application Data
(60) Provisional application No. 63/458,296, filed on Apr. 10, 2023.

(51) Int. Cl. G21G 1/00; G21F 5/015; G21G 1/04

(52) U.S. Cl. CPC G21G 1/001; G21F 5/015; G21G 1/0005; G21G 1/04; G21G 2001/0094

(57) ABSTRACT

A method of generating a radionuclide includes receiving a container in a container receptacle of a radionuclide generator, and moving the container in the container receptacle from a first pose to a second pose. The method also includes exposing an interior surface of the container to a precursor radionuclide source while the container is in the second pose, and allowing sufficient time for the precursor radionuclide source to decay into one or more progeny radionuclides and to emanate the one or more progeny radionuclides into the container. The method further includes isolating the precursor radionuclide source from the container while the container is in the first pose.

### CROSS-REFERENCE TO RELATED APPLICATIONS

This application claims the benefit of priority under 35 U.S.C. § 119 (e) of U.S. Application Ser. No. 63/458,296, filed Apr. 10, 2023, the disclosure of which is incorporated herein by reference in its entirety.

### FIELD

Disclosed embodiments are related to radionuclide generators, and related methods of use.

### BACKGROUND

Radionuclides such as lead 212 (²¹²Pb) may be used in various applications. For example, ²¹²Pb may be used as a therapeutic in radiation treatments for various health conditions, including various cancers. Lead 212 may be formed as a progeny radionuclide in the decay chain of a parent radionuclide such as thorium, radon, or radium.

### SUMMARY

In some embodiments, a method of generating a radionuclide may comprise receiving a container in a container receptacle of a radionuclide generator, moving the container in the container receptacle from a first pose to a second pose, and exposing an interior surface of the container to a precursor radionuclide source while the container is in the second pose. The method may further comprise allowing sufficient time for the precursor radionuclide source to decay into one or more progeny radionuclides and to emanate the one or more progeny radionuclides into the container. The method may include isolating the precursor radionuclide source from the container while the container is in the first pose.

In further embodiments, a radionuclide generator may comprise a container module including a container receptacle configured to receive a container. The container module may be configured to move the container in the container receptacle between a first pose and a second pose. The radionuclide generator may further comprise a source module configured to receive a precursor radionuclide source and configured to selectively expose an interior surface of the container to the precursor radionuclide source in an exposed configuration and isolate the interior surface of the container from the precursor radionuclide source in an isolated configuration.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

In the drawings, each identical or nearly identical component that is illustrated in various figures may be represented by a like numeral. For purposes of clarity, not every component may be labeled in every drawing. In the drawings:

FIG. 1 is a schematic of a thorium series decay chain;

FIG. 2 is a perspective view of a radionuclide generator according to one embodiment, with the loading cover removed from the loading port;

FIG. 3 is a cutaway perspective view of a radionuclide generator in a loading configuration, according to one embodiment;

FIG. 4 is a cutaway perspective view of a radionuclide generator in a generating configuration, according to one embodiment;

FIG. 5A is a top view of a source module of a radionuclide generator, wherein the precursor radionuclide source is in an extended configuration;

FIG. 5B is a cross-sectional side view of the source module of FIG. 5A, wherein the precursor radionuclide source is in an extended configuration;

FIG. 5C is a cross-sectional side view of the source module of FIG. 5A, wherein the precursor radionuclide source is in a retracted configuration;

FIG. 6 is a side view of a source fitting of a radionuclide generator, according to one embodiment;

FIG. 7A is a cross-sectional top view of a source fitting of a radionuclide generator with a source module inserted into the source fitting and a latch of the source fitting in an engaged position;

FIG. 7B is the cross-sectional top view of the source fitting of FIG. 7A, with the latch in a disengaged position;

FIG. 8 is a cross-sectional side view of a container receptacle of a radionuclide generator according to one embodiment, with a container disposed within the container receptacle;

FIG. 9 is a top view of a container drive assembly of a radionuclide generator according to one embodiment;

FIG. 10 is a cross-sectional side view of a container drive assembly of a radionuclide generator according to one embodiment;

FIG. 11 is a perspective view of portions of a container drive assembly of a radionuclide generator according to one embodiment;

FIG. 12 is a schematic illustration of a radionuclide generator, according to one embodiment;

FIG. 13 is a schematic illustration of a radionuclide generator, according to one embodiment;

FIG. 14 is a perspective view of a radionuclide generator, according to one embodiment;

FIG. 15A is a schematic illustration of a radionuclide generator with a plurality of containers in a first pose, according to one embodiment;

FIG. 15B is a schematic illustration of the radionuclide generator according to the embodiment of FIG. 15A with the plurality of containers in a second pose;

FIG. 15C is a schematic illustration of the radionuclide generator according to the embodiment of FIG. 15A with a plurality of precursor radionuclide sources in an extended configuration; and

FIG. 16 is a flow chart illustrating a method of generating a radionuclide using a radionuclide generator, according to one embodiment.

### DETAILED DESCRIPTION

Radionuclides may be used for a variety of applications in such fields as medicine, biology, physics, and other industries. Some radionuclides which possess relatively short half-lives may be appropriate for use in various medical applications, such as targeted alpha-particle therapy (TAT). Radionuclides possessing relatively short half-lives may be preferably for some applications so they can be administered to a patient to treat a particular condition (e.g., any of various cancers such as prostate or carcinoid cancers) while limiting the patient's time of exposure to radioactivity. Treatments with radionuclides having shorter half-lives may therefore result in fewer or less severe side effects than treatments with radionuclides having longer half-lives. In some applications, lead 212 (²¹²Pb) may be a desirable radionuclide for use in TAT or other treatments or applications because it has a half-life of about 10.6 hours.

While shorter half-lives of some radionuclides may be desirable for therapeutic purposes, this may also impose certain difficulties in delivering and storing the radionuclides prior to administering a treatment. For example, it may be difficult to ship and/or store ²¹²Pb because its shorter half-life may cause it to decay into undesirable daughter, granddaughter, or other progeny radionuclides during shipping or storage before it can be administered. On the other hand, a parent, grandparent, or other precursor radionuclide may have a longer half-life, such that the precursor radionuclide may be shipped and/or stored for longer periods without significantly decaying into the undesirable progeny radionuclides.

In view of the above, the inventors have recognized and appreciated the benefits of a radionuclide generator which can produce a desired progeny radionuclide (or “target radionuclide”) from a parent, grandparent, or other precursor radionuclide having a longer half-life. Radionuclide generators according to the present disclosure may enable production of the target radionuclide at or near a location where the target radionuclide is to be used. The target radionuclide may therefore have less time to decay into undesirable progeny radionuclides prior to use. This may facilitate a higher quantity and/or purity of the target radionuclide, thereby improving the efficacy of the target radionuclide during use. For example, a generator may be capable of producing ²¹²Pb from a precursor radionuclide such as thorium 228 (²²⁸Th), radium 224 (²²⁴Ra), or any other precursor radionuclide which can be shipped or stored for significant periods prior to production of the ²¹²Pb. The ²¹²Pb may be produced in the generator at a hospital or treatment facility immediately or shortly before the ²¹²Pb is administered to a patient. In some such applications, the ²¹²Pb will have less time to decay prior to administration. Therefore, when ²¹²Pb is administered, the quantity and/or purity of the ²¹²Pb (and, consequently, the efficacy of the treatment) may be greater than if the ²¹²Pb had been produced off-site and delivered, over a period of time, to the point of administration.

Of course, the generators described herein are not limited to being operated at hospitals, treatment facilities, or other points of use. Rather, some generators described herein may additionally or alternatively be suitable for generating a target radionuclide at a production facility and/or other location distant from where the target radionuclide may be used. In this regard, some embodiments which are fully or partially automated, semi-automated, or otherwise mechanized as described below may facilitate a reliable and/or consistent generation process. Such reliability and/or consistency may be desirable at any location, including a production facility, a treatment facility, and/or any other location appropriate for generating a target radionuclide.

In some embodiments, a generator according to the present disclosure may receive a container in which the target radionuclide may be generated and/or collected. A container may comprise a vessel for collecting or containing the radionuclide and/or a solution containing the radionuclide, such as a vial, a flask, an ampoule, a bottle, or any other appropriate container. In some embodiments, the generator may be configured to expose one or more portions of the container (e.g., an interior surface and/or an interior volume of the container) to a precursor radionuclide. The precursor may decay into one or more progeny radionuclides, including the target radionuclide. In some embodiments, at least one of the one or more progeny radionuclides may be a gas at or near ambient pressure and temperature, such that at least one progeny radionuclide may emanate from the precursor radionuclide as a gas. For example, radon 220 (²²⁰Rn) may emanate in a gaseous form as a progeny radionuclide from a precursor radionuclide comprising radium 224 (²²⁴Ra), thorium 228 (²²⁸Th), and/or any other appropriate precursor radionuclide. However, some gaseous radionuclides, such as ²²⁰Rn, may have a short half-life and may decay into a progeny radionuclide which may be a solid or liquid at or near ambient pressure and temperature. In the example above, ²²⁰Rn may have a half-life of less than a minute, and may decay into ²¹²Pb, which may be a solid at ambient pressure and temperature. Accordingly, it will be appreciated that exposure of an interior surface of a container to a precursor radionuclide comprising ²²⁴Ra and/or ²²⁸Th may cause ²¹²Pb to deposit on the interior surface, as the precursor radionuclide decays into and emanates from the precursor as a gaseous ²²⁰Rn, which further decays into a solid ²¹²Pb when exposed to the environmental conditions within the container which may correspond to a surrounding ambient temperature and pressure (although other temperatures and pressures suitable to permit the formation of liquid or solid lead on the container interior surface may also be used).

Of course, while this sequence is described here with specific reference to a decay chain in the thorium series from ²²⁸Th to ²¹²Pb, it will be appreciated that the present disclosure is not limited to any particular radionuclides or any particular decay chains. In this regard, a generator according to the present disclosure may be configured to receive any appropriate precursor radionuclide, including ²³²Th, ²²⁸Ra, ²²⁸Ac, ²²⁸Th, ²²⁷Th, ²²⁷Ac, ²²⁶Ra, ²²⁴Ra, ²²³Rn, ²²²Rn, ²¹⁹Rn, any combination of the foregoing, or any other appropriate radionuclide or combination of radionuclides. Similarly, a generator of the present disclosure may be configured to produce any appropriate radionuclide, including ²²²Rn, 220Rn, ²¹⁹Rn, ²¹⁶Po, ²¹⁴Pb, ²¹⁴Bi, ²¹⁴Po, ²¹²Pb, ²¹²Bi, ²¹²Po, ²¹¹Pb, ²¹¹Bi, ²¹¹Po, ²¹⁰Pb, ²¹⁰Bi, ²¹⁰Po ²⁰⁸Tl, ²⁰⁸Pb, any combination of the foregoing, or any other appropriate radionuclide or combination of radionuclides. Additionally, although portions of a thorium series decay chain have been described herein, it will be appreciated that a generator according to the present disclosure may be configured to accommodate other decay chains or portions thereof, including a neptunium series, a uranium or radium series, an actinium series, or any portion of the preceding.

In some applications, operation of a generator or other methods of producing a target radionuclide from a precursor radionuclide may be performed manually. For example, in some applications, an interior surface of a container may be exposed to a precursor radionuclide by manually inserting the precursor radionuclide into the container. Additionally, the precursor radionuclide may be removed from the container manually. As will be appreciated, such manual processes may lead to various undesirable results. For example, manual insertion and removal of the precursor radionuclide may lead to accidental and/or incidental contact between the precursor radionuclide and a portion of the container (e.g., an interior surface of the container, a rim of the container, an external surface of the container, etc.). This may cause a quantity of the precursor radionuclide to deposit on the contacted portion of the container. Such a deposit of precursor radionuclide on an external portion of the container may be undesirable because such a deposit of unshielded radioactive material would pose a danger to any person exposed to the container. A deposit of precursor radionuclide on an internal portion of the container may be undesirable due to the resulting contamination of the target radionuclide with the precursor radionuclide. In medical applications, it may be desirable to maintain a stated purity, quantity, and composition of the product during manufacturing to provide an appropriate composition for a prescribed treatment.

In view of the above, the inventors have recognized and appreciated the benefits of a radionuclide generator whose operation may be fully or partially automated, semi-automated, or otherwise mechanized. Such mechanization may reduce the risks associated with purely manual operations in the generation process including, for example the risks of exposure and contamination. Such generators may additionally facilitate a more reliable and/or reproducible generation process by reducing the variation associated with manual operations. In various embodiments, a generator according to the present disclosure may be configured to selectively expose an interior surface of a container to a precursor radionuclide in a consistent fashion. In some embodiments, a generator may include a container module configured to receive the container and a source module configured to receive a precursor radionuclide. The container module and source module may interact in various ways to expose an interior surface of the container to the precursor radionuclide. For example, the container module and source module may be configured to cooperatively align the precursor radionuclide with an opening of the container, such that the precursor radionuclide may be selectively inserted into and/or removed from the container. In some embodiments, the container module may include a container receptacle sized and shaped to receive the container, and may be configured to move the container receptacle and/or to move the container within the container receptacle.

Additionally, in some embodiments, a generator or a container module thereof may be configured to move the container between two or more poses. As used herein, a pose may be a particular position of the container in three dimensional space in combination with a particular orientation of the container (which may include an angular orientation). Accordingly, moving a container between two poses (e.g., a first pose and a second pose) may comprise translating the container, rotating the container, or both translating and rotating the container. Mechanized movement of the container between two or more poses as described herein may facilitate reliable positioning and/or alignment of the container during various operations during, prior to, or subsequent to the generation process. For example, a container may be loaded into the generator in a first pose and moved to a second pose (e.g., translated from a first position to a second position and/or rotated from a first orientation to a second orientation). According to some embodiments, when the container is in the first pose the container may be aligned with a loading port of the generator, which may be an opening in a housing, a container module, or other portion of the generator. Accordingly, when the container is in the first pose, the container may be removable from the generator through the loading port. Additionally or alternatively, when the container is in the second pose, the container or an opening thereof may be aligned with, in contact with, and/or otherwise positioned and/or oriented in an appropriate manner with reference to a source module to permit the interior volume within the container to be selectively exposed to a precursor radionuclide. Accordingly, when the container is in the second pose, the precursor radionuclide may be inserted through an opening of the container to expose an interior surface of the container to the source. In operation, the interior surface of the container may be exposed to the source for an appropriate exposure time to allow the precursor radionuclide to decay into one or more progeny radionuclides, and to allow at least one gaseous radionuclide to emanate from the precursor radionuclide. The exposure time may additionally be sufficient, or additional time may be allowed, to permit the gaseous progeny radionuclide(s) to deposit on the interior surface of the container (either as a solid, a liquid, or both). As will be appreciated, the exposure time may be predetermined to generate a predetermined quantity of a target progeny radionuclide. In various embodiments, the container may be moved back to the first pose for unloading, or the container may be moved to a third pose different from the first pose so the container may be unloaded from the generator. As will be appreciated, a generator and/or a container module thereof may be configured to move a container and/or a container receptacle between any appropriate number of poses.

Further, in some embodiments, a source module may be configured to facilitate selective and/or consistent exposure of the container (or an interior surface thereof) to the precursor radionuclide. A precursor radionuclide may be disposed on a portion of the source module. In some embodiments, the source module may include a precursor radionuclide source on which the precursor radionuclide may be disposed. As described below, a precursor radionuclide source (or simply, “source”) may be any material which includes a precursor radionuclide. The source module may include a source holder configured to receive a source. Further, the source module may be configured to selectively expose or isolate the precursor radionuclide and/or precursor radionuclide source. For example, the source module may be configured to selectively move a source between an exposed configuration and a retracted configuration. In some embodiments, the source module may comprise a shaft. The shaft may include a source holder configured to receive the source, and may allow the precursor radionuclide and/or the source to be moveable between a retracted position and an extended position. In the retracted position, the source may be isolated within the source module. For example, in the retracted position, the source may be isolated from a container and/or from an ambient environment by one or more gas-tight seals. In the extended position, the source may be exposed. For example, in some embodiments, the generator may be configured such that the precursor radionuclide and/or the source is extendable into a container disposed within the container module. Accordingly, in some embodiments, when the precursor radionuclide and/or the source is in the extended position, the source or source holder may be extended through an opening of the container to expose an interior surface of the container to the precursor radionuclide. After a period of exposure time, the precursor radionuclide and/or the source may be moved to the retracted position to isolate the interior surface of the container from the precursor radionuclide.

In order to further reduce a risk that the precursor radionuclide may contaminate the container, the source module may additionally be configured to maintain a spacing between the source or source holder and the container during at least a portion of the generation process, or throughout the entire generation process. In some embodiments, a source module or a shaft thereof may be configured to maintain a spacing between the source holder, as well as the source contained therein, and the container (or an interior surface thereof) in the retracted position, in the extended position, and/or during movement between the retracted and extended positions. For example, a source module may be configured to selectively extend and retract the shaft, the source holder, and/or the source through an opening of the container while maintaining a spacing between the container and the shaft or source holder.

Another risk associated with manual operations during a generation process is that a radionuclide (e.g., a precursor radionuclide and/or a progeny radionuclide) may become exposed to a surrounding environment. In some applications, a gaseous progeny radionuclide (e.g., ²²⁰Rn) may emanate from the precursor radionuclide into the surrounding environment. Such leakage of gaseous radionuclides is undesirable.

In view of the above, the inventors have recognized and appreciated the benefits of a radionuclide generator which can reliably and consistently isolate the precursor radionuclide from a surrounding environment when exposure is not desired. Some generators according to the present disclosure may isolate the precursor radionuclide in any appropriate manner, for example by forming one or more gas-tight seals between a space containing a precursor radionuclide and/or a progeny radionuclide and a surrounding exterior environment. In embodiments which include a source module, the source module may be configured to selectively isolate the precursor radionuclide and/or the precursor radionuclide source. For example, in embodiments having a source module which includes a shaft, the source module may further include a sheath at least partially surrounding the shaft. The shaft may be extendable and retractable through the sheath, for example to move the precursor radionuclide and/or the source between extended and retracted configurations. In some embodiments, the shaft and sheath may be configured to cooperatively form one or more gas-tight seals therebetween to isolate the precursor radionuclide. Some embodiments may include one or more o-rings, gaskets, compliant materials, or other seals included in the source module, for example on the shaft, the sheath, or both. In some embodiments, a precursor radionuclide may be disposed on a portion of the shaft that lies between two seals formed with the sheath, such that the precursor radionuclide may be isolated between the two seals when the shaft is retracted into the sheath.

In addition to the above, some generators may include materials which may at least partially block emitted nuclear radiation from escaping the generator during use. For example, some generators may include housings and/or shielding components which may be formed from dense and/or radiation-opaque metals, alloys, or composites which may include steel, lead, tungsten, tin, antimony, bismuth, aluminum, copper, and/or any other appropriate shielding material(s). Although useful for safety purposes, some such materials may be difficult and/or expensive to obtain, manufacture, handle, ship, or otherwise work with in production of generators.

In view of the above, the inventors have recognized and appreciated the benefits of a radionuclide generator having at least a portion which may be removed or replaced without requiring replacement of the entire generator. In some embodiments, at least a portion of a source module may be configured to be removeable from a generator, such that a single generator may be used with multiple different source modules and/or precursor radionuclide sources. For example, a user may replace a source module if the source is depleted, or if a different precursor radionuclide is desired. According to some embodiments, a source module may be selectively couplable to a generator or a generator housing using a source fitting which may include one or more latches, clasps, snaps, magnets, fasteners, adapters, detents, threaded engagements, or any other appropriate coupling. Further, the source fitting may be configured to form a gas-tight seal at an interface between the source module and the generator or generator housing, and/or to align a portion of the source module (e.g., a shaft, a sheath, a source holder, and/or a precursor radionuclide source) with the container or a portion thereof (e.g., a rim and/or an opening of the container).

Additionally or alternatively, in some embodiments, at least a portion of a source module may be configured to be removeable from the source module, such that portions of a source module may be reused with multiple different sources or precursor radionuclides. In embodiments where the source module includes a shaft and/or a sheath, various portions of the shaft and/or various portions of the sheath may be removeable such that the various portions may be replaced and/or reused. For example, in some embodiments, a shaft of a source module may comprise a source holder on which a source may be disposed, and a rod configured to allow the source holder to be extended and retracted. The source holder may be coupled to the rod by one or more pins, clasps, snaps, adapters, threads, detents, fasteners, friction fits, magnets, and/or any other appropriate coupling. Decoupling of the rod from the source holder may allow the rod to be removed and coupled to a different source holder. Additionally, in some embodiments where the shaft is at least partially surrounded by a sheath, the sheath or a portion thereof may optionally remain coupled to the source holder in order to maintain an isolated configuration of the source holder. For example, in embodiments where one or more gas-tight seals is formed between the shaft and the sheath to isolate the source, the gas-tight seal may be maintained during removal of the rod and/or other portion(s) of the source module.

As will further be appreciated, the various materials and components of a generator may be exposed to radiation from the radionuclides within the generator. The radiation may cause deterioration in and/or damage to the generator materials over time. The rate of deterioration and/or damage to the materials, and consequently a useful life of the material, may be influenced by the intensity of radiation emitted from the radionuclides. For example, a component adjacent to a precursor radionuclide source with a radiation intensity of 10 gigabecquerels (GBq) may deteriorate faster and/or have a shorter useful life than a similar component adjacent to a source with a radiation intensity of 10 megabecquerels (MBq).

In view of the above, the inventors have recognized and appreciated the benefits of a generator which can accommodate multiple precursor radionuclide sources and/or multiple containers associated with the multiple sources. In some embodiments, a generator may include two or more source modules and/or two or more container modules. In embodiments having a plurality of sources and/or a plurality of containers, each individual source may be selected to have a lower radiation intensity without significantly reducing the production rate of a desired progeny radionuclide as compared with a single-source generator having a comparatively higher radiation intensity. This reduced intensity emitted from each individual source may improve the useful life of the generator or its various components as compared to the higher-intensity, single-source generator.

Of course, the number of sources and/or containers a generator may be configured to accommodate, as well as the radiation intensity of the source or sources, may vary greatly depending upon the application. In this regard, the disclosure of generators having multiple sources does not obviate the utility of a high-intensity source or a single-source generator. Further, it should be appreciated that generators configured to accommodate multiple sources and/or multiple containers may be used with sources of any intensity, as there may be other benefits to a generator configured to accommodate multiple high-intensity sources which will be apparent from the present disclosure. For example, the ability to expose and/or isolate multiple sources by a single action from a user or operating system (e.g., by the actuation of a single actuator), and/or the ability to move multiple containers between various poses by a single action, may present efficiency benefits during operation. Accordingly, it should be appreciated that both single-source generators and multi-source generators may be configured to accommodate any radiation intensity, as the disclosure is not limited in this regard.

As noted above, in various embodiments, a precursor radionuclide source may include any appropriate substrate material which a precursor radionuclide may be incorporated with. In some embodiments, a source may be impregnated, coated, or otherwise loaded with the precursor radionuclide in any appropriate manner. This may include loading the substrate with a liquid and/or solid precursor radionuclide. The substrate may be porous in some embodiments to facilitate infiltration and/or coating of the substrate with the precursor radionuclide. Further, the precursor radionuclide source may comprise any appropriate natural or synthetic substrate material to carry the precursor radionuclide, including any appropriate ceramic, plastic, polymer, metal, natural fiber, synthetic fiber, glass, mineral, paper, quartz, or any other appropriate substrate material. In some embodiments, a precursor radionuclide source may include a wool material, for example a quartz wool, a glass wool, a mineral wool, a metal wool (e.g., a steel wool). Additionally, a precursor radionuclide source may be formed in any appropriate regular or irregular geometry. In some embodiments, a precursor radionuclide source may be formed as a disc, an elongate disc, a cylinder (including an annular cylinder, a solid cylinder, or a combination thereof), a tablet, a block, a chip, a sphere, a sheet, a plate, a ball, a rod, or any other appropriate geometry.

Further to the above, it will be appreciated that a rate at which a gaseous source progeny may emanate from the source may be influenced by a surface area of the source substrate material. Therefore, in some embodiments, it may be desirable to provide a porous source substrate material in order to increase the rate of emanating by increasing the surface area of the source. For example, in various embodiments, a source material may have any appropriate porosity. In some embodiments, a source material may have a porosity greater than or equal to 30%, 40%, 50%, 60%, 70%, or any other appropriate porosity. Additionally or alternatively, the source material may have a porosity less than or equal to 99%, 90%, 80%, 70%, 60%, or any other appropriate porosity. Combinations of the foregoing are also contemplated, including, for example, greater than or equal to 30% and less than or equal to 99%, greater than or equal to 50% and less than or equal to 90%, and/or any other appropriate combination of the foregoing. Of course, while particular ranges for the porosity of the source material are provided above, it will be appreciated that other porosities, both greater and less than those provided, are also contemplated as the disclosure is not limited in this regard.

Additionally, in various embodiments, a source substrate material may have any appropriate pore size and the pores may be interconnected with one another to form an open porous structure. In some embodiments, a source material may have a pore size greater than or equal to 0.5 micrometers (μm), 5 μm, 30 μm, 40 μm, 50 μm, or any other appropriate pore size. Additionally or alternatively, the source material may have a pore size less than or equal to 200 μm, 100 μm, 80 μm, 60 μm, 40 μm, or any other appropriate pore size. Combinations of the foregoing are also contemplated, including, for example, greater than or equal to 0.5 μm and less than or equal to 200 μm, greater than or equal to 30 μm and less than or equal to 40 μm, and/or any other appropriate combination of the foregoing. Of course, while particular ranges for the pore size within the source material are provided above, it will be appreciated that other pore sizes, both greater and less than those provided, are also contemplated as the disclosure is not limited in this regard.

Further, a precursor radionuclide of a radionuclide generator (e.g., a precursor radionuclide disposed on a precursor radionuclide source) may be provided in any appropriate mass or quantity. In some embodiments, a precursor radionuclide source may have a mass greater than or equal to 10 micrograms (μg), 50 μg, 100 μg, 250 μg, 500 μg, or any other appropriate mass. Additionally, in some embodiments, a precursor radionuclide source may have a mass less than or equal to 1000 μg, 750 μg, 500 μg, 250 μg, or any other appropriate mass. Combinations of the foregoing are also contemplated, including greater than or equal to 10 μg and less than or equal to 1000 μg, greater than or equal to 50 μg and less than or equal to 250 μg, greater than or equal to 250 μg and less than or equal to 500 μg, or any other appropriate combination of the foregoing. Of course while particular ranges for the mass of the precursor radionuclide are provided above, it will be appreciated that other masses, both greater and less than those provided, are also contemplated as the disclosure is not limited in this regard. As will be appreciated, the mass or quantity of the precursor radionuclide disposed on a precursor radionuclide source may influence a useful life of the precursor radionuclide source.

Relatedly, a precursor radionuclide source may further be configured to emit any appropriate radiation intensity. In some embodiments, a precursor radionuclide source may have an intensity mass greater than or equal to 10 MBq, 100 MBq, 250 MBq, 500 MBq, or any other appropriate intensity. Additionally, in some embodiments, a precursor radionuclide source may have an intensity less than or equal to 10 GBq, 4 GBq, 2 GBq, 1 GBq, or any other appropriate intensity. Combinations of the foregoing are also contemplated, including greater than or equal to 10 MBq and less than or equal to 10 GBq, greater than or equal to 10 MBq and less than or equal to 100 MBq, greater than or equal to 1 GBq and less than or equal to 4 GBq, greater than or equal to 1 GBq and less than or equal to 2 GBq, or any other appropriate combination of the foregoing. Of course while particular ranges for the intensity of the precursor radionuclide are provided above, it will be appreciated that other masses, both greater and less than those provided, are also contemplated as the disclosure is not limited in this regard. As will be appreciated, the mass or quantity of the precursor radionuclide disposed on a precursor radionuclide source may influence a useful life of the precursor radionuclide source.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

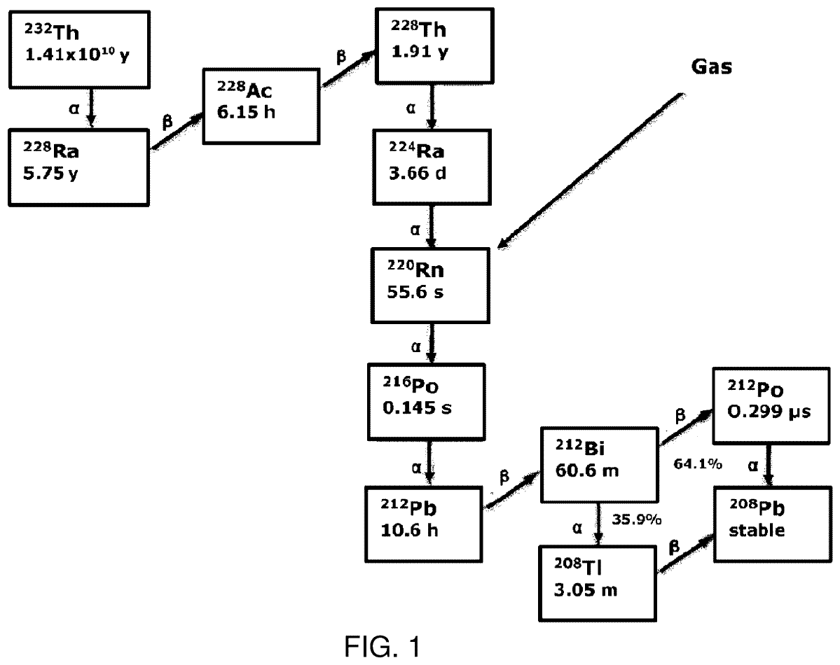

FIG. 1 depicts a diagram of an exemplary thorium series decay chain beginning with thorium 232 (²³²Th). The half-life of each radionuclide in the decay chain is noted in the figure. It will be noted that the radon 220 radionuclide (²²⁰Rn) has a half-life of only 55.6 seconds and decays into polonium 216 (²¹⁶Po) for a brief period (note that the half-life of ²¹⁶Po is only 0.145 seconds) before decaying into a lead 212 radionuclide (²¹²Pb). It will further be noted from FIG. 1 that ²²⁰Rn may be a gas at ambient pressure and temperature. Accordingly, it will be appreciated that when a source which includes a precursor radionuclide to ²²⁰Rn (e.g., 224Ra, ²²⁸Th, ²²⁸Ra, ²³²Th, or ²²⁸Ac) is exposed to a portion of a container, the precursor radionuclide may decay into the gaseous ²²⁰Rn. The gaseous ²²⁰Rn may then decay into ²¹²Pb and may deposit onto the exposed portion of the container as ²¹²Pb.

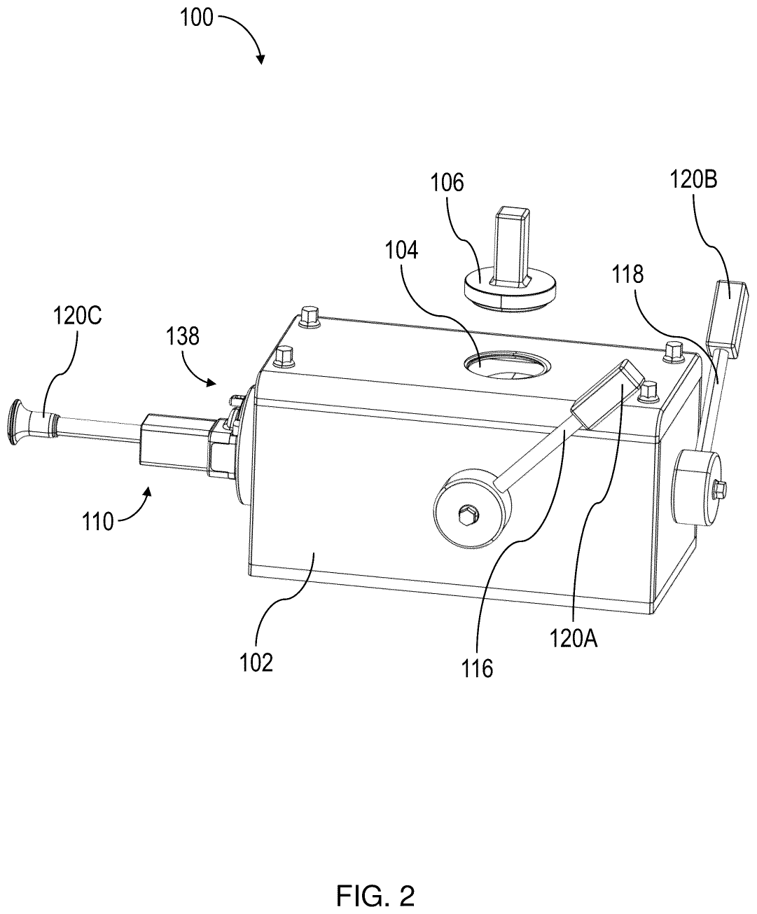

FIG. 2 depicts a perspective view of a radionuclide generator 100 according to one embodiment. In the embodiment shown, the generator 100 may include a housing 102 configured to at least partially contain, surround, or otherwise house various portions of the generator 100. The housing 102 may be formed from any appropriate material, including any appropriate metal, plastic, ceramic, composite, or other material. In some embodiments, the housing may be formed from stainless steel or any other appropriate material. Optionally, the housing 102 may serve a shielding function, such that the housing 102 may resist the escape of nuclear radiation out of the generator 100. In some such embodiments, the housing 102 or some portion thereof may be formed from an appropriate shielding material, such as lead, tungsten, or any other appropriate material.

In some embodiments, the housing 102 may include a loading port 104. The loading port 104 may comprise an opening in the housing 102 through which a container may be passed in order to load the container into the generator 100 and/or to unload the container from the generator. In this regard, the loading port 104 may be sized and shaped to receive a container and to allow the container to pass through the loading port. Additionally, the generator 100 may further comprise a loading cover 106. The loading cover 106 may be configured to selectively open and close the loading port 104. For example, the loading cover 106 or a portion thereof may be partially insertable into and removable from the loading port 104 to open and close the loading port. In various embodiments, the loading cover may be selectively couplable to and/or retainable within the loading port using snaps, latches, clasps, threads, detents, friction fittings, or any other appropriate interface. Further, the loading cover and loading port may be configured to form a gas-tight seal when the loading cover is inserted into the loading port. For example, at least one of the loading cover and the loading port may include one or more gaskets, o-rings, compliant material, or any other appropriate type of seal. In some embodiments, both the loading cover and the loading port may include gaskets, o-rings, or other seals.

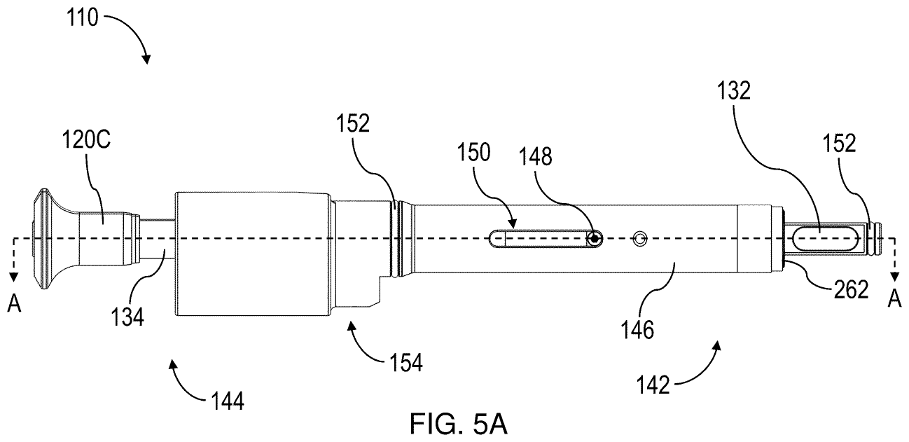

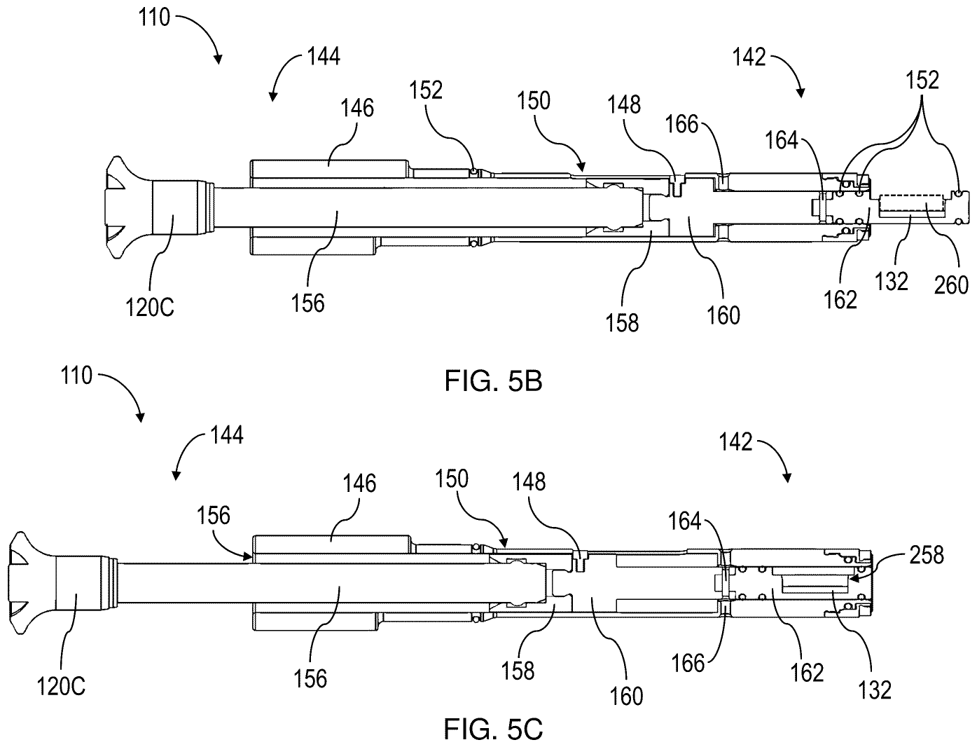

Additionally, in some embodiments, the generator 100 may include one or more actuators to allow various portions of the generator to be moved between different poses (i.e., translated and/or rotated) or otherwise manipulated. An actuator may move, manipulate, and/or control a portion of a generator in any appropriate manner, including the use of a button, a dial, a knob, a switch, a handle, a pushrod, a plunger, a lever, a linear actuator, a rotary actuator, a biasing member, and/or any other appropriate manual or automated control or combination of controls. In some embodiments, an actuator may facilitate and/or enable movement of a container, movement of a precursor radionuclide source, movement of a portion of the generator, and/or movement of any other appropriate component. In the embodiment shown, the generator 100 may include a first lever 116 having a first handle 120A and a second lever 118 having a second handle 120B. As will be discussed in detail below, the first and second levers 116, 118, may be configured to move a container within a container receptacle. For example, operation of each of the first and second levers may cause a rotation and/or a translation of the container within the container receptacle to move the container between a first pose and a second pose. Additionally, a source module 110 may include a source handle 120A configured to enable movement of a precursor radionuclide source. For example, the source handle 120A may be operated to move the source between an extended configuration and a retracted configuration, as will be described below (see FIGS. 5A-5C).

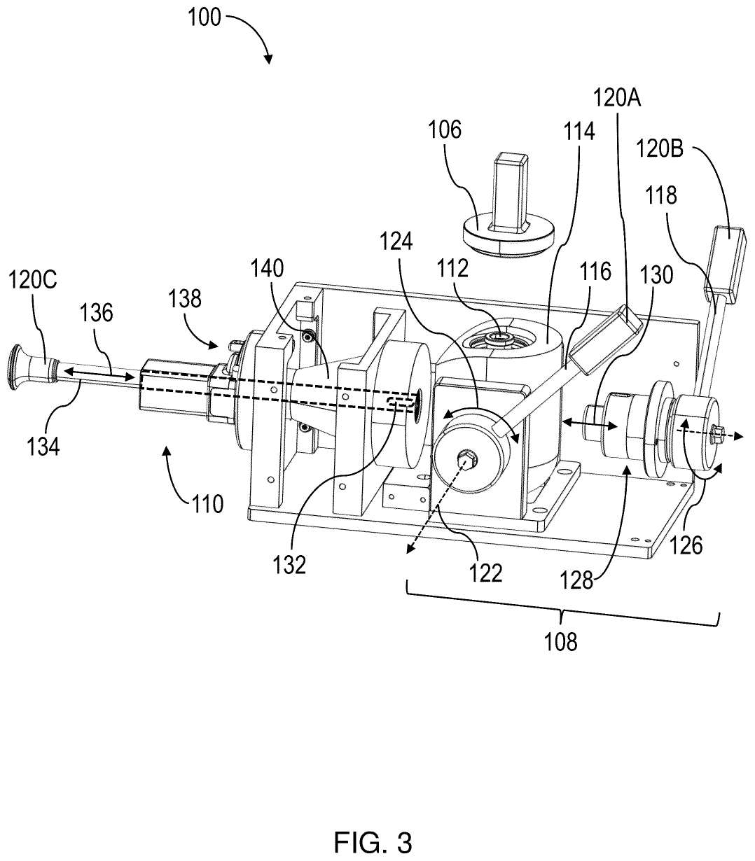

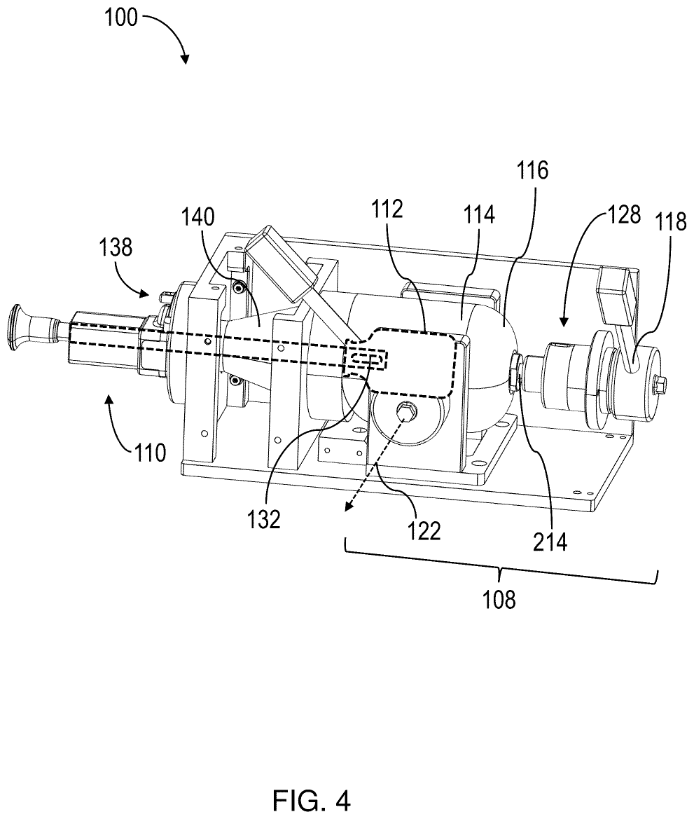

As best shown in the cutaway views of FIGS. 3-4, a generator may include a container module 108 and a source module 110. The container module 108 may be configured to receive a container 112. In some embodiments, a container module may include a container receptacle 114. The container receptacle 114 may be configured to receive the container 112, for example by including a cavity sized and shaped to receive the container. The container module 108 may further be configured to move the container within the container receptacle. In some embodiments, the container module may be configured to move the container between various poses within the container receptacle. For example, a container 112 may be loaded into a generator 100 in a first pose (e.g., the position and orientation of the container in FIG. 3) and moved into a second pose (e.g., the position and orientation of the container in FIG. 4). In the first pose, the container may be positioned and/or oriented to be loaded into or unloaded from the generator, for example by aligning the container (or a portion thereof, such as an opening, a neck, a rim, or any other appropriate portion) with a loading port of the generator. In the second pose, the container may be positioned and/or oriented to selectively receive a precursor radionuclide source through the opening of the container into an interior volume of the container. In some embodiments, when the container is in the second pose, the container and/or an opening thereof may be aligned with a precursor radionuclide source and/or with a portion of a source module 110 (e.g., a shaft, a sheath, or another portion of a source module).

In various embodiments, a container module may include any appropriate actuator to move the container receptacle and/or the container within the container receptacle. For example, a container module may include one or more of: a button, a dial, a knob, a switch, a handle, an actuator, a pushrod, a plunger, a lever, a linear actuator, a rotary actuator, a biasing member, and/or any other appropriate manual or automated control or combination of controls. Further, one or more of the actuator(s) may optionally be configured to be actuated and/or manipulated manually, semi-automatically, automatically, and/or in any other appropriate manner, for example using an end effector or manipulator of a robot or other machine. In the embodiment shown, the container module may include the first and second levers 116, 118 having first and second handles 120A, 120B. Each of the first and second handles 120A, 120B may be configured to facilitate actuation of the respective lever by an end effector or manipulator of a robot or other machine. For example, each handle may have a rectilinear or cuboid geometry to provide flat, opposing surfaces to facilitate engagement of the handle by an end effector or manipulator. Of course, it will be appreciated that a handle may alternatively be configured to facilitate actuation in any appropriate manner, including manual actuation. For example, the source handle 120C of the source module 110 may be tapered, rounded, or otherwise ergonomically shaped to facilitate manual operation, for example by an operator wearing a leaded glove. As will be appreciated, the source handle may alternatively be configured for mechanized actuation, for example by having a rectilinear or cuboid geometry, a T-shaped geometry, or any other geometry to which an end effector or manipulator of a robot or other mechanized actuator may engage.

In some embodiments, a container module 108 may include multiple actuators such as the first and second levers 116, 118. Each actuator may be configured to move the container 112 between two or more poses, for example by translating the container 112 and/or the container receptacle 114 to change a position of the container 112, and/or by rotating the container and/or the container receptacle to change an orientation of the container 112. In some embodiments, a first actuator may rotate the container and/or container receptacle, and a second actuator may translate the container and/or container receptacle. For example, the first lever 116 may rotate about a first lever axis 122 in the direction(s) of arrow 124. The first lever 116 may be operatively coupled to the container receptacle 114, such that when the first lever 116 is rotated about the first lever axis 122, the container receptacle 114 and any container 112 disposed therein may also be rotated about the first lever axis 122. This rotation may at least partially control an alignment of the container 112 or an opening thereof with the source module 110 or a portion thereof (e.g., a source 132, a source holder, and/or a shaft 134 of the source module 110).

Additionally or alternatively, the second lever 118 may be rotated in the direction(s) of arrow 126 in order to selectively extend, retract, or otherwise actuate a container drive assembly 128. As will be described below, a drive tip 214 may be selectively extended and retracted in the drive direction(s) of arrow 130 with rotation of the second lever 118. In some configurations (e.g., when the container receptacle 114 has been rotated to align the container 112 with the source module 110, as shown in FIG. 4), extension and retraction of the drive tip may move the container 112 along the drive direction 130. For example, the drive tip 214 may engage with the container receptacle 114 or a portion thereof to urge the container 112 within the container receptacle in a first drive direction toward the source module 110 and/or toward the second pose. Additionally, retraction of the drive tip 214 may cause or allow the container 112 to move in a second drive direction opposite the first drive direction (e.g., away from the source module 110). For example, in some embodiments, the container receptacle 114 may include a biasing member to urge the container in the second drive direction, such as a compression spring, an extension spring, an air spring, a pneumatic cylinder, or any other appropriate biasing member configured to apply a force that biases the container toward the source module.

While the container module 108 has been shown and described having two actuators, it will be appreciated that any appropriate number of actuators may be included in a container module or generator of the present disclosure, including a single actuator, three actuators, or any other appropriate number, as the disclosure is not limited in this regard. Additionally, one or more actuators other than rotatable handles may be used to provide the desired actuation as previously noted.

The source module 110 may be configured to receive a precursor radionuclide source 132 (the dashed lines in the views of FIGS. 3-4 denote internal structures). In some embodiments, the source module 110 may include a shaft 134 on which the precursor radionuclide source 132 may be disposed. The source module 110 may further be configured to selectively expose an interior surface of the container 112 to the precursor radionuclide source in an exposed configuration and isolate the interior surface of the container from the precursor radionuclide source in an isolated configuration. For example, the shaft 134 may be selectively extendable and retractable, such that the source module 110 may be configured to move the source 132 between a retracted configuration in which the source 132 is isolated from the container 112 (e.g., the configuration of FIG. 3) and an extended configuration in which the interior surface of the container 112 is exposed to the source 132 (e.g., the configuration of FIG. 4). In other words, an exposed configuration may be an extended configuration, and/or an isolated configuration may be a retracted configuration, although exposed and isolated configurations may additionally or alternatively correspond to other arrangements. In some embodiments, the shaft may include a handle 120 to facilitate or enable movement of the source 132 between the retracted and extended configurations, for example in the directions of arrow 136.

In some embodiments, the source module 110 or a portion thereof may be removable from the generator 100. For example, the generator 100 or a housing thereof may be configured to removably receive the source module 110. In some embodiments, the housing may include a source fitting 138, which may be configured to removably receive the source module 110 or any portion thereof. In various embodiments, a source fitting may couple the source module or portion thereof to the housing or the generator in any appropriate manner, including using one or more latches, clasps, snaps, detents, fasteners, magnets, threaded engagements, and/or any other appropriate coupling. Additionally, in some embodiments, a source fitting and/or a source module may be configured to provide a gas-tight seal at an interface between the source fitting and the source module, for example using one or more gaskets, o-rings, compliant materials, or other gas-tight seals at the interface.

Further, in some embodiments, the source fitting 138 may include and/or may be coupled to a source shield 140. The source shield 140 may be configured to at least partially block nuclear radiation from escaping the generator during use. In some embodiments, the source shield may include an internal cavity sized and shaped to receive and at least partially surround the source and/or to receive a shaft, sheath, a source holder, and/or other portion(s) of a source module. In some embodiments, the cavity may extend from a first end portion of the source shield 140 to a second end portion, such that the source may be extended and/or retracted through an entire length of the source shield. As will be appreciated, such a source shield may be formed from any appropriately radiation-opaque material, including any appropriate metal such as steel, lead, tungsten, tin, antimony, bismuth, aluminum, copper, and/or any other appropriate material or combination of materials that are capable of providing sufficient shielding for the generator. Additionally, a source shield may be formed in any appropriate geometry, including any appropriate irregular or regular geometry such as a cylindrical geometry, a conical geometry, a cuboid geometry, a pyramidal geometry, or any combination of regular or irregular geometries. For example, in the embodiment shown, the source shield 140 may be formed having a stepped cylindrical geometry, such that the source shield may have a first end, a second end, and a middle section between the first end and the second end. The first end may be formed as a first cylinder having a first diameter, and the second end may be formed as a second cylinder having a second diameter greater than the first diameter. The middle section may be formed as a cone, the cone having a varying diameter which may increase from the first end to the second end. It will be appreciated that a diameter at any given point along a length of the source shield may be selected based on an expected degree or quantity of nuclear radiation at that location. For example, in applications where the source is expected to reside predominantly within the second end portion, the diameter at the second end portion may be greater than the diameter at the first end portion removed from the source.

FIG. 5A depicts a top view of a source module 110 according to one embodiment. The source module 110 may have a proximal end portion 142 and a distal end portion 144. The proximal end portion 142 may be configured to be inserted into a generator or a portion thereof (e.g., into a source fitting, a shield element, and/or a housing of the generator). In some embodiments, the distal end portion may be configured to extend from the generator when the proximal end portion is inserted into the generator. A shaft 134 may extend between the distal end portion and the proximal end portion. In some embodiments, a source module may include a sheath which may at least partially surround and extend along a length of at least a portion of a shaft. For example, the sheath 146 may at least partially surround the shaft 134 along at least a portion of a length of the shaft. The shaft 134 may be configured to be selectively extendable and retractable through the sheath 146, for example by pushing or pulling in an axial direction on a source handle 120C disposed at a distal end of the shaft. In some embodiments, the source module 110 may be configured to limit a movement of the shaft within the sheath. For example, in the embodiment shown, the shaft 134 may include a pin 148 extending radially outwards from the shaft. The pin 148 may be disposed or disposable within a slot 150 formed in the sheath 146. The slot 150 may be an elongate opening formed along a portion of the sheath 146, and may be sized and shaped to receive the pin 148 and to allow the pin 148 to move therein between a first end of the slot 150 and a second end of the slot, thereby limiting the linear translation of the shaft in at least one of an extension direction (i.e., in a direction toward the proximal end 142) and a retraction direction (i.e., in a direction toward the distal end 144) which may be aligned with a longitudinal axis of the shaft in some embodiments.

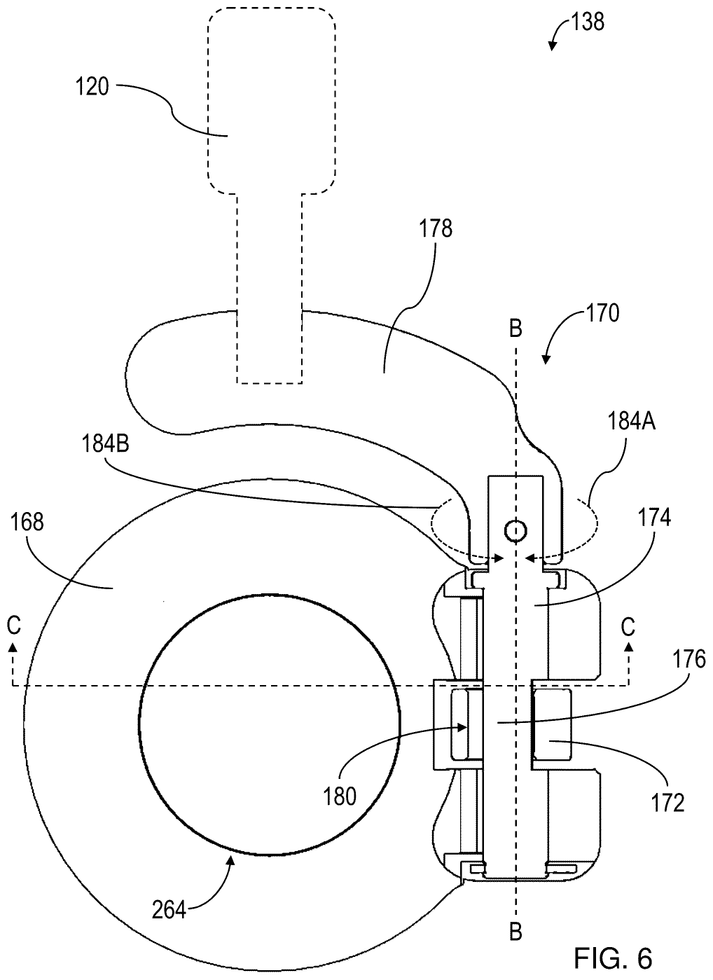

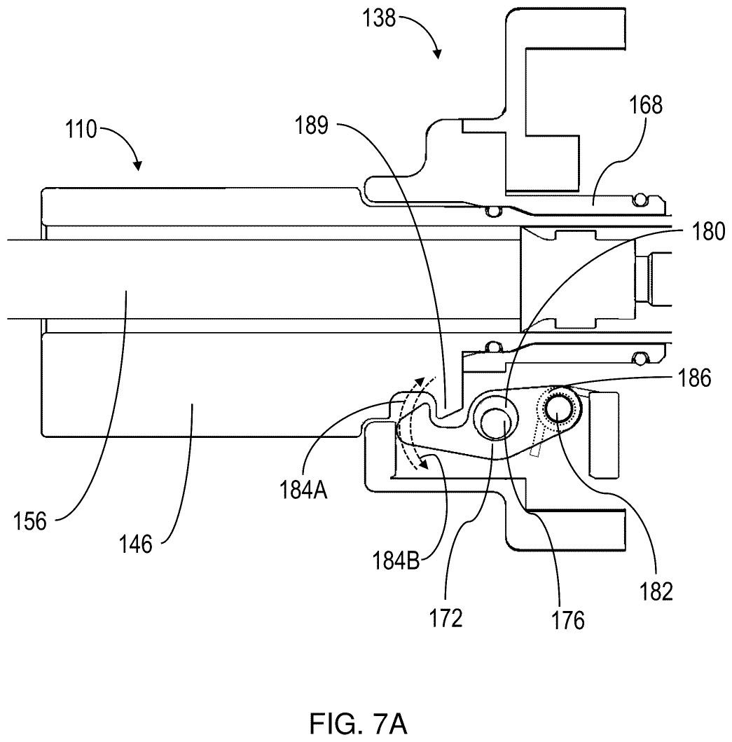

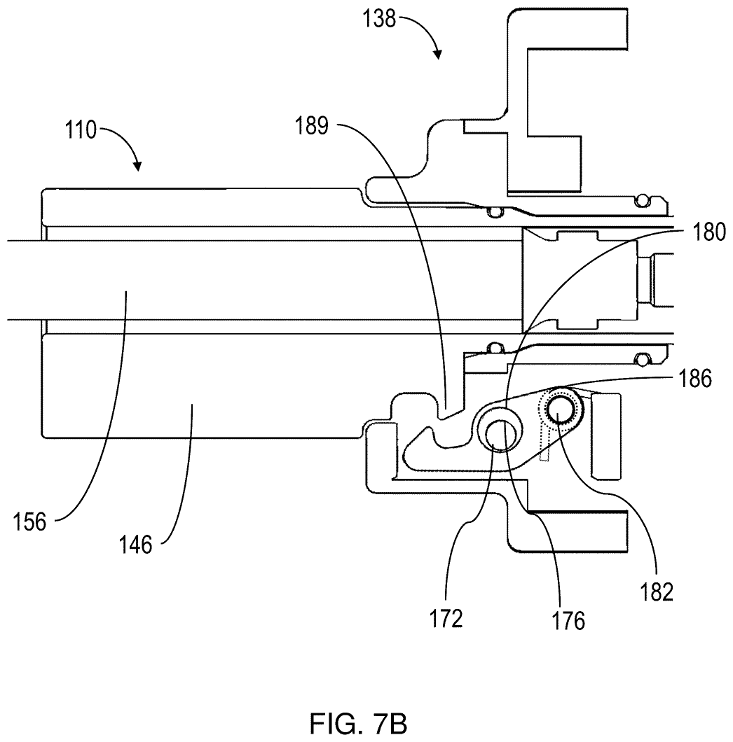

In some embodiments, a source module may be configured to be removable from a generator or a portion thereof (e.g., a housing or a source fitting of the generator). For example, a source module may include a coupling 154. In various embodiments, a source module may include any appropriate coupling to removably couple the source module or portion thereof to the generator, including one or more latches, clasps, snaps, detents, fasteners, magnets, threaded engagements, and/or any other appropriate coupling. One non-limiting embodiment of a coupling will be described in detail with reference to FIGS. 6-7. Additionally, in some embodiments, a source module may be configured to provide a gas-tight seal at an interface between the generator and the source module, for example using one or more gaskets, o-rings, or other gas-tight seals at the interface. In the embodiment shown, the coupling 154 may include an o-ring 152 to form a gas-tight seal at an interface between the generator and the source module.

FIGS. 5B-5C depict cross-sections of the source module 110 of FIG. 5A taken along line A-A. FIG. 5B depicts the source 132 in an extended configuration, while FIG. 5C depicts the source 132 in a retracted configuration. In some embodiments, a shaft of a source module may include multiple components. For example, the shaft 134 may include a rod 156, an adapter 158, a shield element 160, and a source holder 162. In some embodiments, the rod 156 may be an elongate member configured to extend from a distal end portion 144 of the source module 110 toward the proximal end portion 142. Additionally, the rod 156 may include or may be coupled to a source handle 120C at a distal end of the rod to allow the shaft 134 (or a rod thereof) to be moved. In some embodiments, a shield element 160 may be included in the shaft (e.g., at a distal location relative to the source) in order to at least partially block nuclear radiation from escaping the generator from the source 132. As with other shielding components described herein, a shield element may be formed from any appropriate material, including lead, tungsten, and/or others described herein or otherwise known in the art. A source holder 162 may be configured to receive a precursor radionuclide source, for example by including an opening, slot, or other receptacle sized and shaped to receive the source. In the embodiment shown, a source slot 258 may be formed in the source holder 162. The source slot 258 may be sized and shaped to receive the source 132, which may be formed as an elongate disc in the embodiment shown. Although the source is depicted as an elongate disc in the embodiment shown, it will be appreciated that a source may be formed in any appropriate regular or irregular geometry, including a cylinder (including an annular cylinder, a solid cylinder, or a combination thereof), a disc, a tablet, a block, a chip, a sphere, a sheet, a plate, a ball, a rod, or any other appropriate geometry.

Similarly, although the source slot 258 is depicted as a cavity or hollowed-out portion of the source holder, it will be appreciated that a source holder may include any source receptacle appropriately formed to receive a correspondingly shaped source. For example, in some embodiments, the source holder may be configured to engage with and retain a source around a perimeter and/or periphery of the source while opposing sides of the source are exposed. For example, two opposing openings may be formed in the source holder to retain the source. Additionally or alternatively, a single opening may extend through the source holder from a first side of the source holder to an opposing second side, and the opening may be configured to engage with and retain the source while allowing opposing sides of the source to be exposed. Such constructions may increase a surface area of the source which is exposed when the source is in an extended configuration.

Further to the above, in some embodiments the source holder may include a source post extending proximally from its proximal end which may be sized and shaped to be insertable into a hole or bore of a corresponding source. For example, in some embodiments, at least a portion of a source may be formed as a cylinder including a bore formed through at least a portion of the cylinder (e.g., along a central axis of the cylinder) so as to form an annular cylinder. In some such embodiments, the source holder may be configured to receive the annular cylinder, for example by including a source post sized and shaped to be insertable into the bore. Additionally, in some such embodiments, a fixturing aperture may be formed in a transverse direction (e.g., a radial direction) through the source and the source post, such that a dowel may be inserted into the fixturing aperture to secure the source to the source holder. However, it will be appreciated that an annular cylinder may be secured to a rod of a source holder in such embodiments using any appropriate method or construction, including a press fit or friction fit, a snap fit, an adhesive, a threaded engagement, or any combination thereof.

In some embodiments, a source cap 260 may additionally be provided with the source holder 162. A source cap 260 may be a removable portion of the source holder 162, and may be sized and shaped to at least partially cover the source 132 when the source is disposed on the source holder. The source cap may be any appropriate shielding or non-shielding material, including any appropriate metal, plastic, natural or synthetic polymer, or any other appropriate material.

In some embodiments, an adapter may be included to couple various components of a shaft together, and/or to provide and/or facilitate a slidable engagement between the shaft and an inner surface of a sheath or cavity in which the shaft may be disposed. In the embodiment shown, the adapter 158 may engage with the rod 156 at a distal end portion of the adapter, and with the shield element 160 at a proximal end portion of the adapter. In various embodiments, an adapter may engage with a rod, a shield element, or other portion of a shaft by any appropriate permanent or removable coupling, including one or more snaps, friction fittings, threaded fittings, detents, magnets, fasteners, pins, dowels, adhesives, welds, and/or any other appropriate coupling.

Additionally or alternatively, in some embodiments, two or more portions of a shaft may be joined together directly (i.e., without the use of an adapter) using any appropriate coupling, including those described herein. For example, in the embodiment shown, a shield element 160 and a source holder 162 may be joined by a dowel 164. The dowel 164 may extend through respective through holes of both the source holder and the shield element, which may be aligned to allow the dowel 164 to pass therethrough. In some embodiments, a dowel may be removable. For example, in the embodiment shown, the dowel 164 may be configured to align with an aperture 166 formed in the sheath 146. The aperture 166 may allow a user to remove the dowel 164, thereby decoupling the source holder 162 from the shield element 160.

In addition to the dowel 164 being removable, the pin 148 may be removable from the shaft or the shield element 160. For example, the pin 148 may be a threaded fastener, engageable with a threaded bore of the shaft or a portion thereof (e.g., a threaded bore of the shield element, adapter, rod, or other portion). As will be appreciated, when the pin 148 and the dowel 164 are removed, the source module 110 may be partially disassembled such that the source handle 120C, the rod 156, the adapter 158, and the shield element 160 may be removed from the sheath 146, while the source holder 162 may remain isolated and/or sealed within the sheath. In some embodiments, this may enable certain portions of the source module 110 (e.g., the source handle, the rod, the adapter, and/or the shield element) to be reused, while other portions (e.g., the source holder and/or the sheath) may remain coupled to and/or in isolating engagement with the precursor radionuclide source 132.

In the retracted configuration shown in FIG. 5C, the precursor radionuclide source 132 may be isolated from a container or an interior surface thereof, a portion of the generator, and/or an ambient environment surrounding the generator or source module. In some embodiments, when the source is isolated from an object or area, a gaseous progeny radionuclide which may emanate from a precursor radionuclide disposed on the source may be inhibited from reaching and/or contacting the object or area. Accordingly, in some embodiments, a source module may include at least one seal configured to form a gas-tight interface to isolate the source. For example, a source module may include a plurality of seals, each forming a gas-tight interface between the shaft and the sheath. Some such seals may be gas-tight, moveable and/or slidable, and/or resealable. In some embodiments, a plurality of seals may include one or more seals located on a first side of a source, and one or more seals located on a second side of the source. For example, in the embodiment shown, one or more seals (e.g., o-rings 152, although other types of seals may be incorporated in addition to or instead of o-rings) may be disposed on a proximal side of the source 132 to form a gas-tight interface on the proximal side. In this regard, when the source module is 110 is installed into a generator and a container is loaded into the generator, the container may be isolated from the source by one or more of the o-rings 152 (or other seal(s)). Additionally or alternatively, one or more seals (e.g., two o-rings 152 as shown in the figure) may be disposed on a distal side of the source 132 to form a gas-tight interface on the distal side such that the seals may isolate the source 132 from an ambient environment. Of course, although the embodiment shown depicts two o-rings on the distal side and one o-ring on the proximal side, it will be appreciated that any number of o-rings or other types of seals may be included at any appropriate location in a source module according to the present disclosure. For example, in some embodiments, two or more seals may be included on the proximal side and/or the distal side of a source, as the disclosure is not limited in this regard. In some embodiments, the sheath may additionally or alternatively include o-rings or other sealing members to form a gas-tight interface between the sheath and the shaft. Further, an o-ring 152 or other sealing member may additionally be provided on an external portion of the sheath 146 to form a gas-tight interface between the source module 110 and a source fitting of the generator when the source module is inserted into the source fitting.

Further to the above, a source module may include one or more seals to selectively engage with and form a gas-tight interface with a container to prevent a gaseous progeny radionuclide from escaping through the interface between the source module and the container. For example, the source module 110 and/or the sheath 146 may include a container seal 262 disposed on its proximal end. The container seal 262 may be configured to engage with a container or a portion thereof (e.g., a rim or an opening of a container) to form a gas-tight interface between the container and the source module and/or the sheath. In various embodiments, the container seal 262 may comprise any appropriate seal, including an o-ring, a gasket, a portion or a coating of a compliant material, or any other structure appropriate for forming a gas-tight interface with the container.

FIG. 6 depicts a cross-sectional view of a source fitting 138 according to one embodiment, the source fitting having been removed from the generator for clarity of illustration. A source fitting 138 may be configured to removably receive a source module 110. In some embodiments, a source fitting may include a collar 168 configured to receive a portion of the source module. For example, the collar 168 may include an opening 264 sized and shaped to receive a portion of a source module, including a shaft, a sheath, a source, and/or any other appropriate portion of a source module. In some embodiments, the collar or the opening thereof may include a seal configured to form a gas-tight interface between the collar and a source module received therein. For example, the collar 168 may include one or more o-rings, gaskets, compliant materials, or other sealing members within the opening 264.

Additionally, in some embodiments, a latch assembly 170 may extend from or be formed adjacent to the collar 160. The latch assembly may removably and/or selectively engage with a source module or a coupling thereof to allow the source module to be inserted into and removed from the source fitting 138. In some embodiments, a latch assembly may include a latch 172. The latch 172 may be configured to engage with a catch of a source module, as will be described with reference to FIG. 7. The latch 172 may be operatively engaged with a camshaft 174 configured to actuate the latch 172 to engage and/or disengage the source module. The latch 172 may include a first through hole 180. A camming portion 176 of the camshaft 174 may be disposed within the first through hole 180. A diameter of the first through hole 180 may be larger than a diameter of the camming portion 176, such that the latch 172 may move relative to the camming portion 176 up to a distance equal to the difference between the diameters. Additionally, a cross-section of the camming portion 176 may be eccentric to a central axis B-B of the camshaft 174, such that rotation of the camshaft 174 about its central axis B-B may cause an eccentric rotation of the camming portion 176, which may in turn cause the camming portion 176 to actuate the latch 172. In some embodiments, the camshaft 174 may be fixed to or integrally formed with a source release lever 178, such that turning of the source release lever 178 may cause rotation of the camshaft 174 about the central axis B-B. Additionally, in some embodiments, a source release lever 178 may include or be coupled to a source release handle 120D, which may be configured to facilitate automated, semi-automated, mechanized, or manual operation as described above.

FIGS. 7A and 7B show top views of a cross-section of the source fitting 138 taken along line C-C, with a source module 110 included to illustrate the selective engagement between the source module and the source fitting. FIG. 7A shows a latch assembly in an engaged position according to one embodiment, in which the source fitting 138 may be cooperatively engaged with the source module 110 to retain the source module in the generator. FIG. 7B shows a latch assembly in a disengaged position, in which the source module may be released from the source fitting, such that the source module may be removed from the generator. As shown in the figures, the latch 172 may be selectively engageable with a catch 189 formed on the source module 110 or a coupling thereof. The latch 172 may include a second through hole, which may be engaged with a pivot post 182 of the source fitting. As will be appreciated with reference to the figures, a diameter of the pivot post may be substantially similar to a diameter of the second through hole, such that the engagement between the latch and the pivot post may constrain a translational movement of the latch 172 while allowing the latch 172 to pivot about the pivot post 182. A torsion spring 186 may be provided around the pivot post 182 and in contact with the latch 172, such that the torsion spring 186 may bias the latch 172 in the direction of arrow 184A. This biasing force may maintain a contact between an internal surface of the first through hole 180 and the camming portion 176.

In operation, a source module 110 may be slid into the collar 168 of the source fitting 138. A sloped portion of the catch 189 may contact and slide against a correspondingly sloped and/or hooked portion of the latch 172 to urge the latch in the direction of arrow 184B as the source module is slid progressively further into the collar. When the sloped portion of the catch has slid past the sloped portion of the latch, the torsion spring may urge the latch in the direction of arrow 184A to the engaged position. When the source module is to be removed, the camshaft 174 may be rotated in direction of arrow 184B, for example by actuating the source release lever 178. When the camshaft 174 is rotated about its central axis B-B in direction 184B, the eccentricity of the camming portion 176 in cooperation with the biasing force of the torsion spring 186 may cause the camming portion to urge the latch to rotate about the pivot post 182 in the direction of arrow 184B towards the disengaged position, thereby allowing the catch to slide back past the latch such that the source module may be removed.

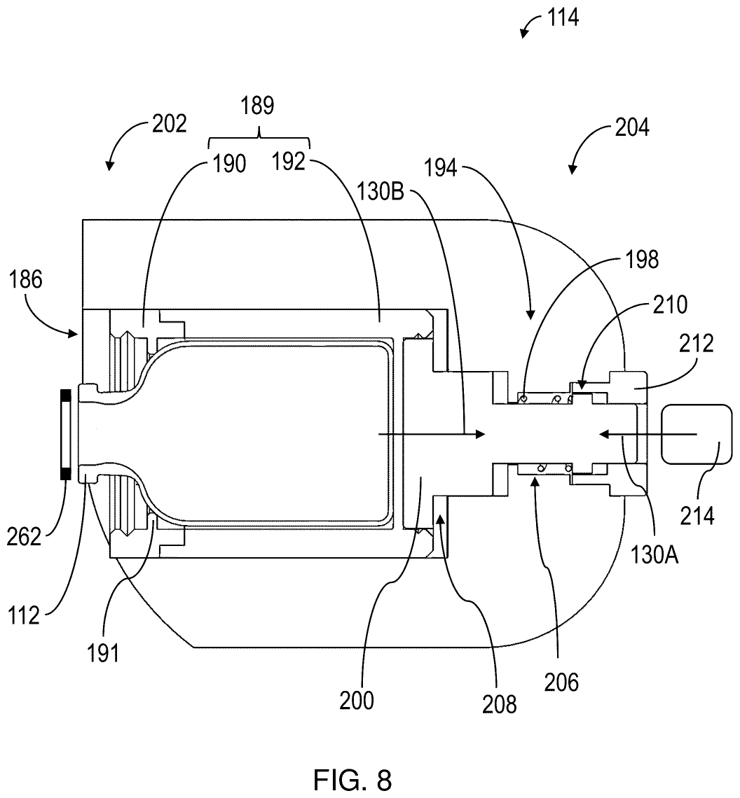

FIG. 8 is a cross-sectional side view of a container 112 disposed in a container receptacle 114 according to one embodiment. As noted above, the container receptacle 114 may include a cavity 186 formed in a first end portion 202 of the container receptacle. The cavity 186 may be sized and shaped to receive the container 112. In some embodiments, the cavity 186 may optionally be sized and shaped to receive a container fitting 188, which may be configured to receive and/or secure the container 112 within the container receptacle 114 or a cavity thereof. In some embodiments, the container fitting 188 may be removable from the container receptacle 114, such that the container may be loaded into the container fitting outside of the generator, and the container fitting may be loaded into the container receptacle with the container disposed therein. Additionally, in some embodiments, the container fitting may comprise two or more pieces. For example, in the embodiment shown, the container fitting 188 may include a first portion 190 and a second portion 192. In some embodiments, the first portion 190 may include a retaining collar 191 configured to retain the container within the container fitting. The first and second portions 190, 192 may be configured to be releasably engaged with one another, such that the pieces may be disassembled to allow a container to be inserted into and/or removed from the container fitting 188. In various embodiments, portions of a container fitting may be releasably engaged by any appropriate coupling, including a friction fit, a threaded fitting, one or more snaps, one or more magnets, one or more detents, and/or any other appropriate coupling. Additionally, in various embodiments, the container fitting 188 may be formed from any appropriate material, including any appropriate metal, plastic, ceramic, composite, rubber, or any other material or combination of materials. For example, in some embodiments, the container fitting may comprise a plastic such as polyetheretherketone (PEEK), nylon, polyethylene (including high-density or low-density polyethylene), polyvinyl chloride (PVC), polyurethane (PU), acrylonitrile butadiene styrene (ABS), polycarbonate (PC), or any other appropriate plastic. Further, in some embodiments, the container fitting may comprise a natural or synthetic rubber, such as ethylene propylene diene monomer (EPDM), styrene-butadiene rubber, butyl, nitrile butadiene rubber, silicone, or any other appropriate rubber.

Some container modules or container receptacles thereof may optionally be configured to allow, facilitate, and/or enable movement of a container within the container receptacle. In some embodiments, a container receptacle may include a container actuation assembly configured to allow, facilitate, and/or enable a translation of the container in at least one direction. For example, the container receptacle 114 may include a container actuation assembly 194 configured to move the container 112 in the first and second drive directions of arrows 130A, 130B. In some embodiments, the container actuation assembly 194 may include a spring 198 and a piston 200 disposed within a bore 206 of the container receptacle. The bore 206 may be sized and shaped to receive the spring 198 and the piston 200, and may be formed in a second end portion 204 of the container receptacle, opposite a first end portion 202 in which the cavity 186 may be formed. In the embodiment shown, a first end 208 of the piston may be in contact with or otherwise operably engaged with the container fitting 189. In this regard, the first end 208 of the piston may be operably engaged with the container fitting 189 in any appropriate manner, including friction fitting, threaded engagement, snap fitting, magnetic engagement, and/or any other appropriate coupling. Further, it will be appreciated that in embodiments which do not include a container fitting, the first end 208 of the piston may be in contact with or otherwise operably engaged with the container itself (e.g., the piston may simply press against the container, or the piston may include a portion configured to form a friction fit or other engagement with the container). A second end 210 of the piston may be in contact with a spring 198 disposed in the bore 206. In some embodiments, the spring 198 may be a compression spring configured to bias the piston 200 toward the second end portion 204 of the container receptacle 114 (e.g., in the second drive direction 130B), such that the container fitting 188 and/or the container 112 may be biased toward the second end portion 204.

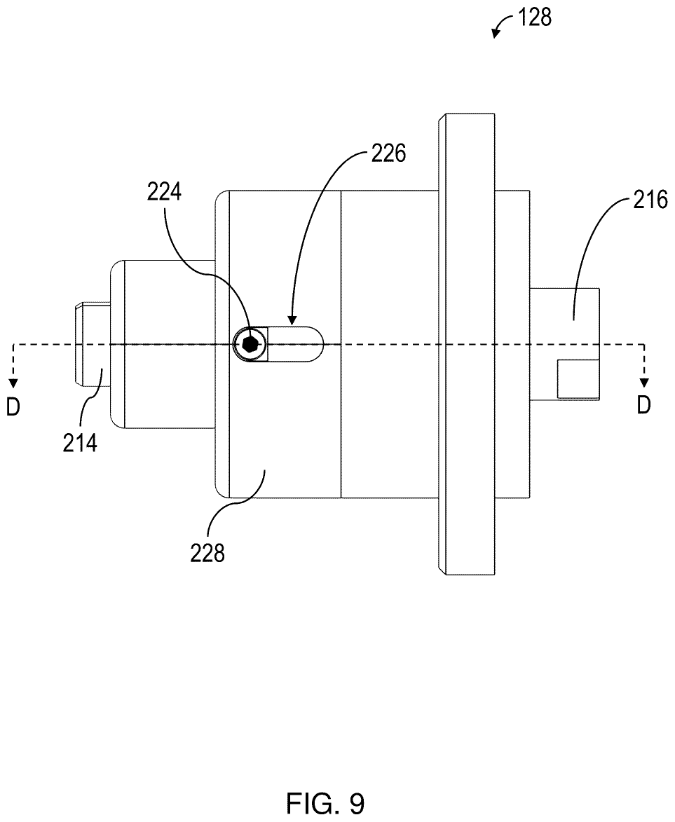

In some embodiments, the container receptacle 114 may further include an endpiece 212 at least partially disposed in and/or extending from the bore 206 at the second end portion 204. The endpiece 212 may be configured to limit a movement of the piston 200 in the direction of the second end portion 204 (e.g., in the second drive direction 130B), for example by including a lip which may cooperate with a corresponding rim at the second end 210 of the piston 200 to stop movement of the piston 200. The endpiece 212 may further be configured to receive a drive tip 214 of a container drive assembly 128 (see FIG. 1 above and FIGS. 9-11 below), for example by including a bore sized and shaped to receive a correspondingly sized and shaped drive tip 214. The drive tip 214 may be extendable and retractable through the endpiece 212 to engage with the piston 200 and to urge the piston 200 toward the first end portion 202 of the container receptacle 114 (e.g., in the first drive direction 130A). In some embodiments, movement of the drive tip 214 against the piston 200 toward the first end portion 202 may urge the container 212 into contact with a seal 262 of a source module to form a gas-tight interface between the container and the source module.

As shown in FIG. 9, a container drive assembly 128 may include a drive tip 214 configured to be selectively extended from and retracted into a drive assembly housing 228 of the container drive assembly. In some embodiments, the container drive assembly 128 may be operably connected to a lever such that operation of the lever may selectively extend and/or retract the drive tip. For example, in the embodiment shown, the container drive assembly 128 may include an outer drive cylinder 216, which may be operably connected to a second lever (e.g., the second lever 118 in FIGS. 1-3), such that turning of the second lever may cause a corresponding rotation of the outer drive cylinder 216.

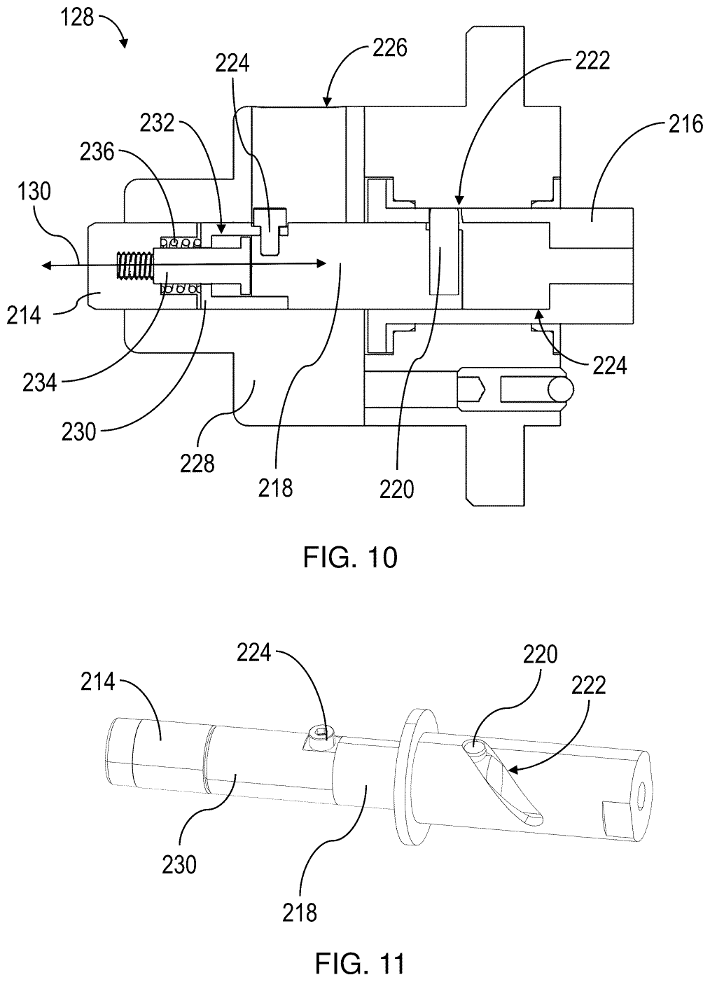

As best understood with reference to FIGS. 10-11, rotation of the outer drive cylinder 216 may cause a corresponding extension or retraction of the drive tip 214. In some embodiments, the outer drive cylinder 216 may be operably coupled to an inner drive cylinder 218, which may be disposed in a bore 224 of the outer drive cylinder. The bore 224 may be sized and shaped to receive the inner drive cylinder. As shown in the cross-sectional view of FIG. 10 taken along line D-D of FIG. 9, the outer drive cylinder 216 may be operably coupled to the inner drive cylinder 218 by a drive pin 220. The drive pin 220 may extend radially out from the inner drive cylinder 218. As will be appreciated, the drive pin 220 may be formed integrally with the inner drive cylinder or may be formed separately and assembled to the inner drive cylinder by any appropriate assembly method, including a threaded engagement, a friction fit, a snap fit, adhesives, magnets, and/or any other coupling. The drive pin 220 may extend from the inner drive cylinder 218 into a drive slot 222 formed in the outer drive cylinder 216. As shown in FIG. 11, the drive slot 222 may be an elongate opening formed in the outer drive cylinder 216. The drive slot 222 may be formed at an angle with respect to a drive direction (e.g., the drive direction of arrow 130) of the container drive assembly, such that rotation of the outer drive cylinder 216 may produce a linear translation of the inner drive cylinder 218 in the drive direction.

In some embodiments, it may be desirable to limit a range of motion of the drive cylinder. Thus, the linear translation of the inner drive cylinder 218 may be guided and/or limited by a limiting pin 224 extending radially from the inner drive cylinder 218. The limiting pin 224 may extend into a linear slot 226 formed in the drive assembly housing 228. The linear slot may be an elongate opening in the drive assembly housing, and may be sized and shaped to receive the limiting pin 224 and to allow the limiting pin 224 to move therein between a first end of the linear slot 226 and a second end of the linear slot, thereby limiting the linear translation of the inner drive cylinder to a distance corresponding to a length of the linear slot 226.

The limiting pin 224 may additionally couple the inner drive cylinder 218 to a cylinder cap 230. The cylinder cap 230 may be disposed on an end of the inner drive cylinder 218, and may define an end bore 232 within which a drive piston 234 may be at least partially disposed. The limiting pin 224 may extend through a through hole of the cylinder cap 230 from the inner drive cylinder 218 to attach cylinder cap 230 to the inner drive cylinder 218. The drive piston 234 may be attached to the drive tip 214, for example by threaded engagement as shown, or by friction fitting, snaps, detents, magnets, or any other appropriate engagement. In some embodiments, a compliant member may be disposed between the drive tip 214 and the cylinder cap 230. For example, in the embodiment shown, a spring 236 may urge the drive tip 214 towards an extended position. The spring 236 may additionally provide compliance to an engagement between the drive tip 214 and a portion of a container or a container receptacle (e.g., the piston 200, or a container fitting in some embodiments), in order to reduce a risk that the container (which may be formed from fragile materials such as glass) may break when the container is urged in the drive direction (e.g., toward the source module).

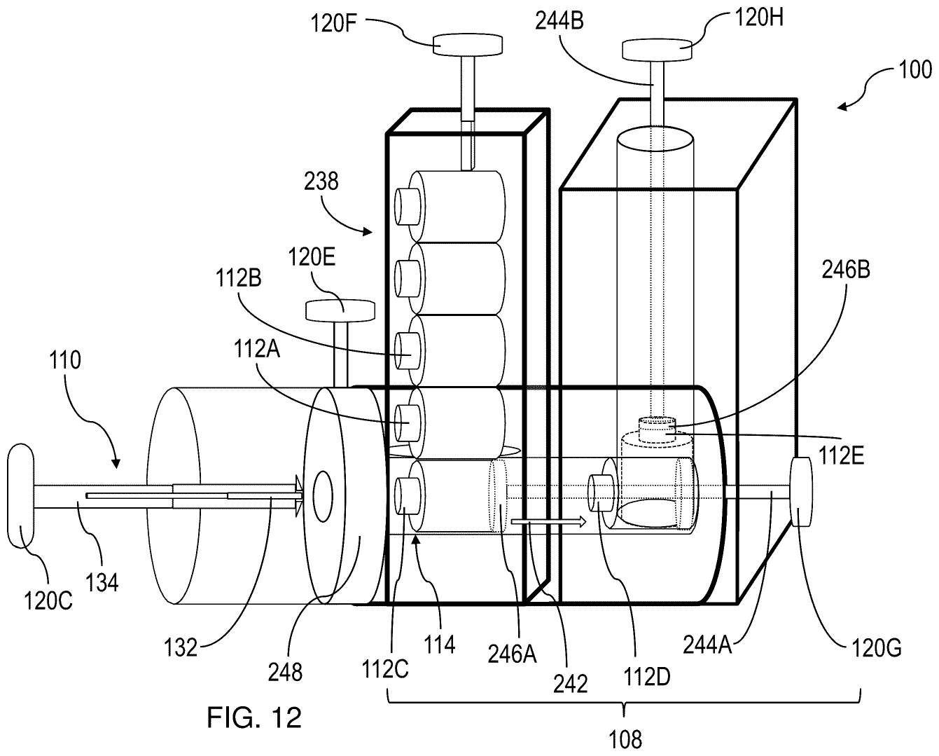

FIGS. 12-14 depict alternative arrangements for radionuclide generators 100 embodying the concepts of the present disclosure. In the schematic of FIG. 12, the generator 100 may include a container feeder 238 configured to store one or more containers (e.g., the first and second containers 112A, 112B) and to move the one or more containers into or through one or more poses. In some embodiments, the container feeder 238 may be configured to advance one or more containers through a series of poses. The series of poses may include and/or terminate in a generating pose, in which the container may be disposed in a container receptacle 114, and in which the container or an opening thereof may be aligned with a precursor radionuclide source 132 disposed on or in a source module 110. A container may be advanced through at least part of a series of poses by sequential translational movement of the container in a container feeder, for example from within a stack of containers into a generating pose as shown. In some embodiments, a generator may include a valve 248 configured to isolate the container receptacle 114 from the source 132. The valve 248 may be configured to be opened to allow the source 132 to pass therethrough, or closed to prevent the source 132 from passing therethrough, for example by operation of a valve handle 120E.

In some embodiments, each container may be loaded into a respective pose, and each container may be advanced through a respective number of poses prior to being advanced to the generating pose. For example, the first container 112A may be loaded into a first feeder pose and may be advanced directly from the first feeder pose to the generator pose, while the second container 112B may be loaded into a second feeder pose and may be advanced from the second feeder pose to the first feeder pose before being advanced to the generating pose. Of course, it will be appreciated that a container feeder may be configured to accommodate any appropriate number of containers, and to advance each container through any appropriate number of poses, as the disclosure is not limited in this regard. Further to the above, in some embodiments, the container feeder 238 may include a feeder handle 120F configured to advance one or more containers loaded into the container feeder into one or more sequential poses, including the generating pose. Additionally or alternatively, a container feeder may be gravity operated, such that removal of a first container from a generating pose may cause a second container to advance from a feeder pose to the generating pose due, in whole or in part, to gravity.

The generator 100 of FIG. 12 may additionally comprise an unloading module 240 configured to move a container from a generating pose to one or more unloading poses (e.g., after a generation process has been completed). In some embodiments, the unloading module 240 may include a first unloading handle 120G configured to move a container from a generating pose (e.g., the pose of the third container 112C) to at least a first unloading pose (e.g., the pose of the fourth container 112D). For example, the first unloading handle 120G may translate a container from the generating pose to the first unloading pose, for example in the direction of arrow 242 which is directed away from the source 132. In some embodiments, the second handle may include or be operably attached to a first grabber arm 244A, which may be operably attached to a first grabber 246A. The first grabber 246A may be configured to form a friction fit with a container and/or to otherwise engage with a container to move the container from the generating pose to at least the first unloading pose. In some embodiments, the unloading module 240 may additionally configured to move a container from the first unloading pose (e.g., the pose of the fourth container 112D) to a second unloading pose (e.g., the pose of the fifth container 112E, illustrated in broken lines to distinguish from the fourth container 112D). For example, the first unloading handle 120G may additionally be configured to rotate the container from the first unloading pose to the second unloading pose. As will be appreciated, an unloading module or a handle thereof may be configured to translate and rotate a container either sequentially or simultaneously. For example, although the above description contemplates translating a container from a generating pose to a first unloading pose, and rotating the container from the first unloading pose to a second unloading pose, the disclosure also contemplates simultaneously translating and rotating the container from the generating pose directly to the second unloading pose. An unloading module 240 may additionally be configured to remove a container from the generator, and/or to facilitate the removal of a container from the generator. For example, the generator 100 of FIG. 12 may include a second unloading handle 120H configured to remove a container (e.g., the fifth container 112E), which may be operably attached to a second grabber arm 244B and/or a second grabber 246B, which may be configured to form a friction fit with and/or to otherwise engage with a container to remove the container from the generator.

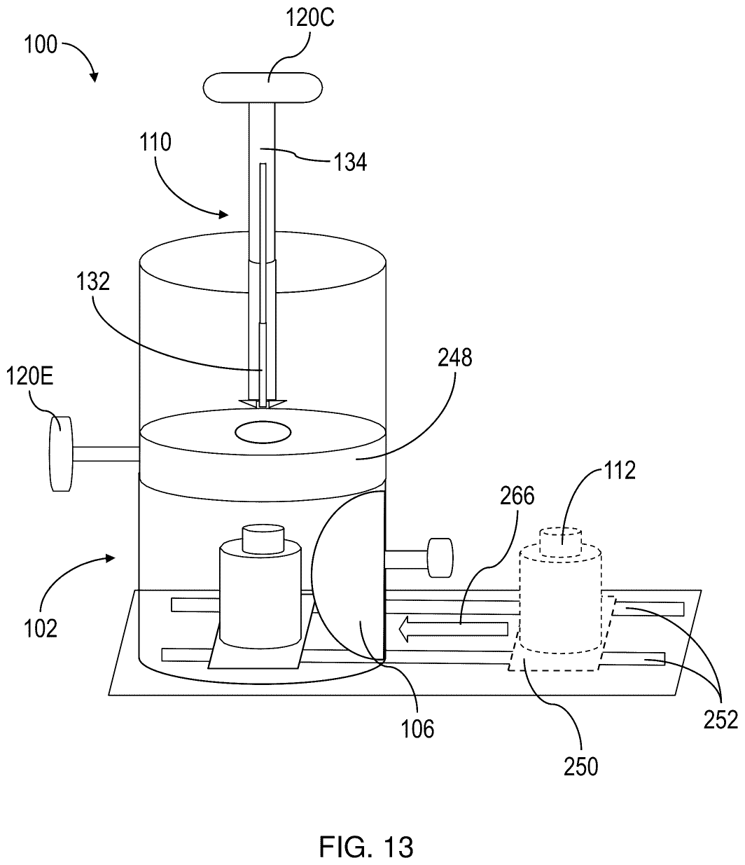

According to the embodiment of FIG. 13, a generator 100 may include a motion stage 250 configured to receive a container 112. The motion stage may be movably attached to one or more motion tracks 252 to facilitate selective movement of the container into and out of the generator. The motion stage may be movable on the motion tracks in any appropriate manner. For example, the motion tracks may be any appropriate tracks or rails, including slide rails, roller rails, flow rails, guide rails, telescoping rails, pneumatic rails, or any other appropriate type of rail and/or track. Further, the motion stage may be movably attached to the motion tracks in any appropriate manner, including roller wheels, track rollers, carriages, trolleys, roller carriages, roller bearings, frictionless bearings, air bearings, pneumatic bearings, ball bearings, or any other appropriate movable attachment. Additionally, the motion stage may be driven by a ball screw drive, a linear motor, a linear actuator, a servo motor, a motor in conjunction with a transmission, a pneumatic drive or motor, and/or any other appropriate drive, motor, or actuator, including a manual drive (e.g., a lever attached to the motion stage).

In some embodiments, the motion tracks may form a motion path along which the motion stage 250 may be configured to move. The motion path may be any appropriate shape, including any appropriate linear or curvilinear shape. For example, the motion path indicated by arrow 266 may be a linear motion path along the motion tracks 252. The motion tracks and motion stage may cooperate to allow a container to be translated from a first pose to a second pose, for example by translating the container along the motion path. In some embodiments, the container 112 may be in a position outside a housing 102 of the generator when the container is in the first pose, and/or the container may be in a position at least partially inside the housing when the container is in the second pose. Additionally or alternatively, the container may be in an orientation such that the container and/or an opening thereof may be aligned with a source module 110 or a precursor radionuclide source 132 thereof when the container is in the second pose.

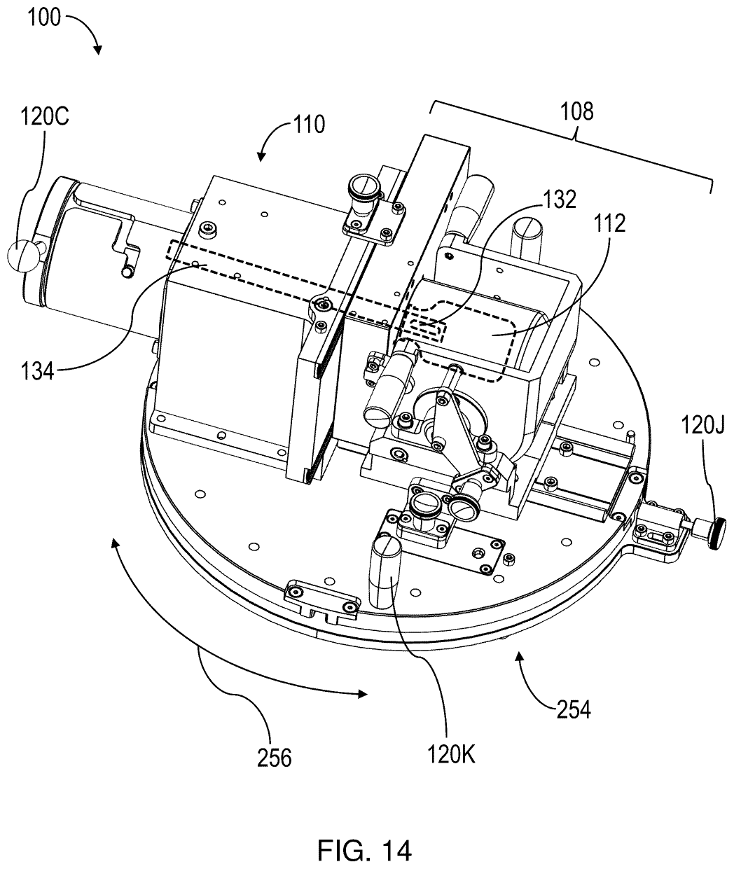

According to the embodiment of FIG. 14, a generator 100 may include a turntable 254. In some embodiments, a container module 108, a source module 110, a housing 102, and/or any other appropriate portion of the generator may be disposed on the turntable 254. The turntable 254 may be configured to rotate the generator or portion(s) thereof in one or more directions, for example in the directions of arrows 256. In some embodiments, a turntable may be operatively coupled to one or more handles to facilitate rotation of the turntable and/or generator. For example, the turntable 254 may include a locking handle 120J configured to selectively allow or resist rotation of the turntable 254. Additionally or alternatively, the turntable 254 may include one or more rotating handles 120K configured to facilitate rotation of the turntable. In some embodiments, the turntable 254 may facilitate rotation of the generator in order to control an orientation of the source 132. For example, the generator may be rotated from a first orientation in which the source is oriented towards an operator of the generator to a second orientation in which the source is oriented away from the operator. In some applications, this arrangement may reduce a risk that the operator may be exposed to nuclear radiation emitted from the source 132.

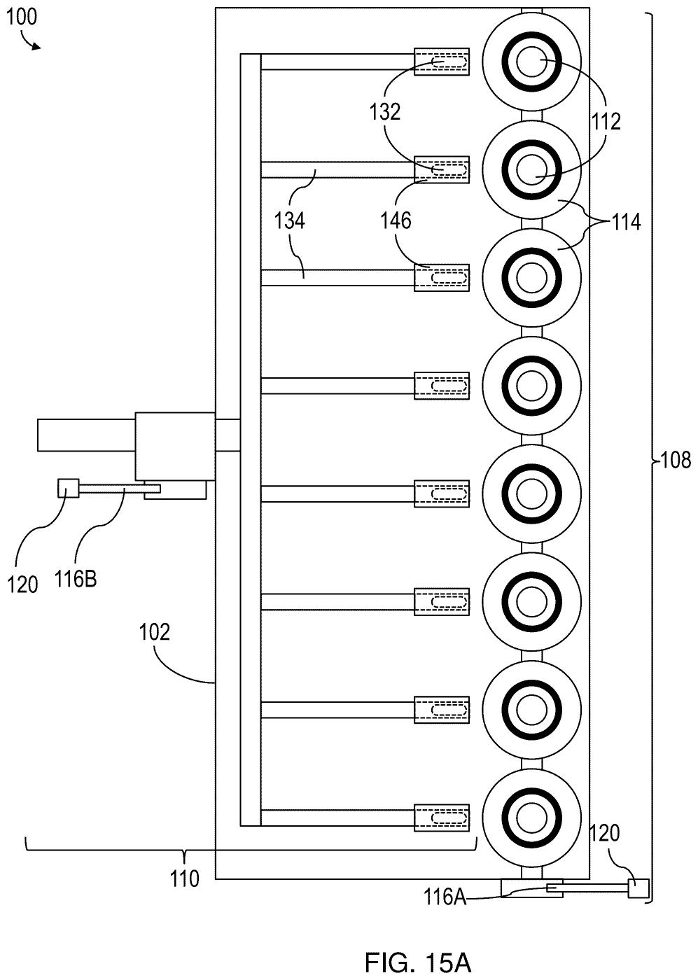

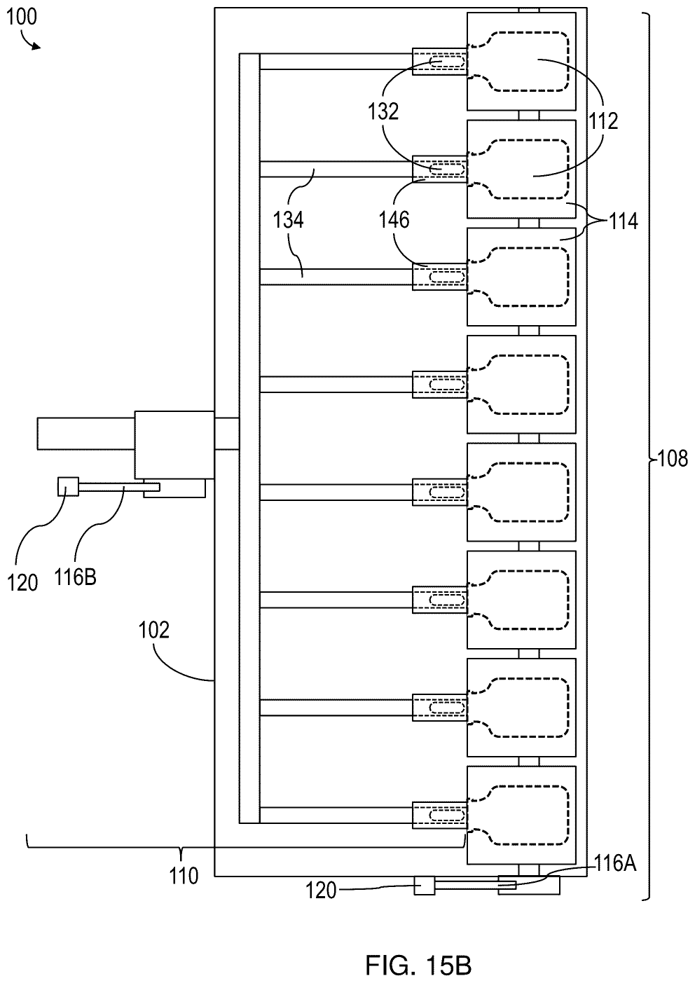

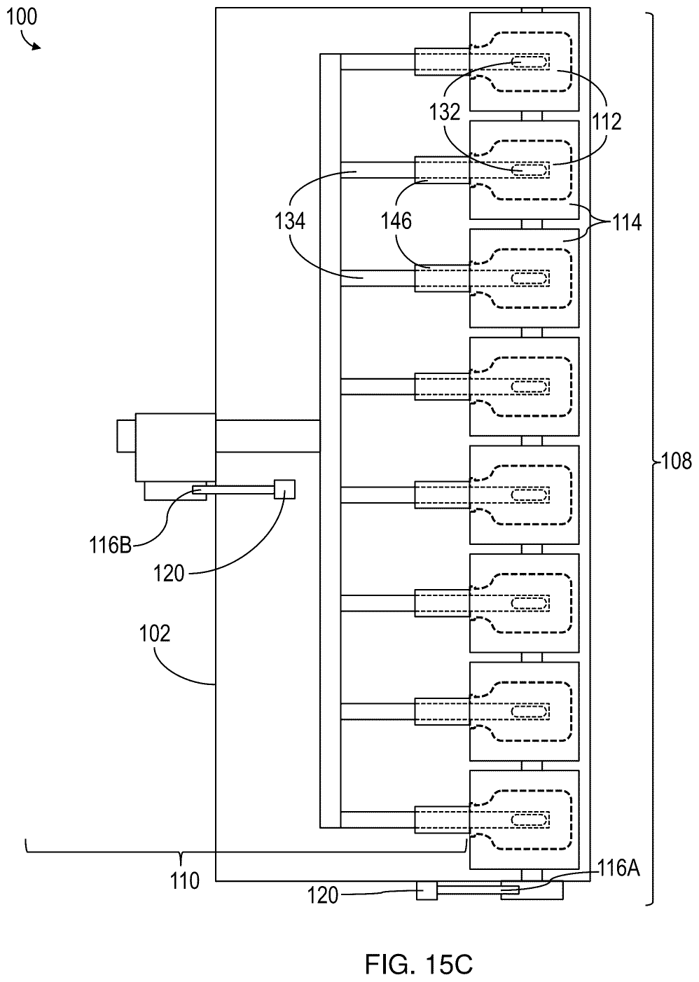

In some embodiments, a radionuclide generator may be configured to receive two or more containers and/or two or more sources. For example, in the embodiment of FIGS. 15A-15C a container module 108 of a generator 100 may be configured to receive a plurality of containers 112. Additionally or alternatively, a source module 110 may be configured to receive a plurality of sources 132. The container module 108 may include a plurality of container receptacles 114, each container receptacle configured to receive a respective container as described herein. The source module 110 may include a plurality of shafts 134, each configured to receive a respective source 132 as described herein.

A container module having multiple container receptacles may be configured to move each container receptacle between two or more poses, such that each container may be moved between two or more poses within a respective container receptacle. In some embodiments, each container and/or container receptacle may be configured to move between poses individually. In some such systems, each container and/or container receptacle may be associated with a respective actuator as described herein. Alternatively, two or more containers and/or container receptacles may be associated with a shared container actuator, such that operation of the shared container actuator may move the containers and/or container receptacles together between various poses. For example, in the embodiment shown, a shared container lever 116A may be actuated to move the containers 112 together between a first pose (as shown in FIG. 15A) and a second pose (e.g., the generating pose of FIGS. 15B-C). As with other embodiments, a shared actuator may include a handle 120 to facilitate automated, partially automated, and/or mechanized operation of the generator 100 as described herein.

Similarly, in a source module having multiple shafts, each shaft may be extendable and retractable through a respective sheath to move a respective precursor radionuclide and/or source between extended and retracted configurations as described herein, such that each precursor radionuclide and/or source may be selectively exposed to and isolated from a corresponding container. In some embodiments, each shaft may be configured to extend and retract individually, such that each source may be exposed or isolated individually. In some such systems, each shaft and/or source may be associated with a respective actuator as described herein. Alternatively, two or more shafts may be associated with a shared source actuator, such that operation of the shared actuator may extend and retract the shafts together to selectively expose and isolate the multiple sources together. For example, in the embodiment shown, a shared source lever 116B may be actuated to retract and extend the shafts 134 together to move the sources 132 together between retracted configurations in which each source 132 is isolated from a respective container 112 (as shown in FIG. 15A), and extended configurations in which each source 132 is exposed to the respective container 112 (FIGS. 15B-C).

As will be appreciated, embodiments which accommodate multiple sources and/or multiple containers may be implemented using any appropriate arrangement, including any of the various means described throughout the present disclosure and/or any combination thereof. For example, such multi-source/multi-container generators may include any aspects of the generators described here, including any aspects of the container modules, source modules, container drive assemblies, source fittings, source holders, container fittings, sheaths, source shields, and/or any other components or assemblies described herein.

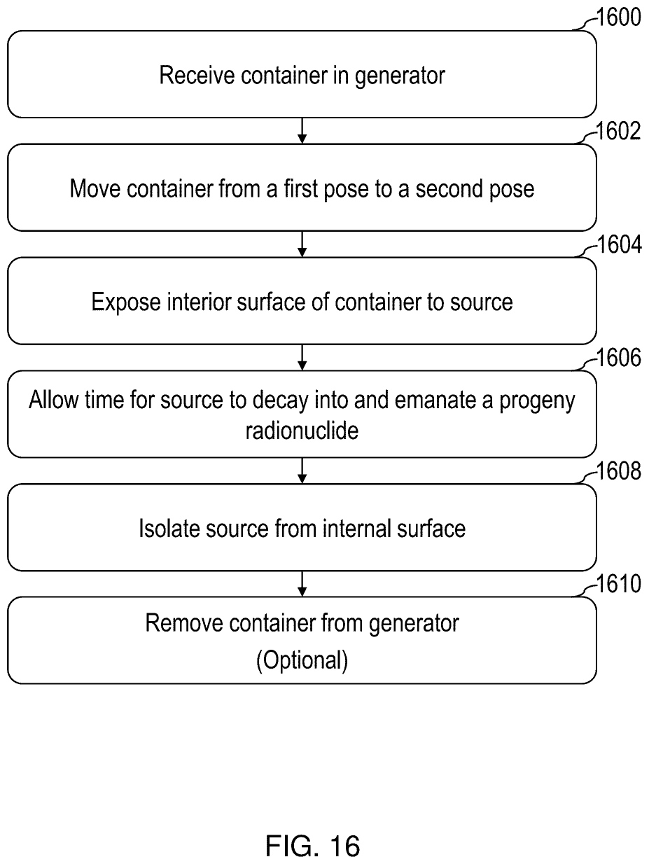

According to the embodiment of FIG. 16, a method of generating a radionuclide may comprise receiving a container in a generator at step 100. Receiving the container in the generator may include removing a loading cover from a loading port and inserting the container through the loading port. Additionally or alternatively, receiving the container in the generator may include receiving the container in a container receptacle of the generator as described herein. In some embodiments, receiving the container in the generator may include removing a container fitting as described herein from the generator or a container receptacle thereof, receiving the container in the container fitting, and receiving the container fitting in the generator or container receptacle. In some such embodiments, receiving the container in the container fitting may comprise removing a first portion of the container fitting from a second portion of the container fitting, receiving the container in the second portion, and attaching the first portion to the second portion to secure the container within the container fitting.

In some methods, step 1600 may include receiving a plurality of containers in a generator. Receiving the plurality of containers in the generator may include receiving the plurality of containers in a plurality of container receptacles. Each container receptacle may be configured to receive a corresponding container. Further, each container receptacle may include a respective container fitting such that, for each container receptacle, receiving the corresponding container may include removing the respective container fitting, receiving the container in the container fitting, and receiving the container fitting in the container receptacle.

At step 1602, the container (or the plurality of containers) may be moved from a first pose to a second pose. In some embodiments, the container(s) may be moved from the first pose to the second pose within the container receptacle(s). Moving the container(s) from the first pose to the second pose may include rotating the container(s) to change an orientation of the container(s), translating the container(s) to change a position of the container(s), or both rotating and translating the container(s) to change both an orientation and a position of the container(s). In some embodiments, the method may further include advancing the container(s) through a series of poses, which may include any appropriate number of poses as described herein. In some embodiments, moving the container from one pose to another pose (e.g., from the first pose to the second pose) may include moving the container into a generating pose in which the container or an opening thereof may be appropriately aligned with a source, a source module, or a portion of a source module (e.g., a shaft, a sheath, a source holder, a seal, etc.) such that the interior volume of the container may be selectively exposed to the source. Similarly, in embodiments having a plurality of containers, each container may be moved into a generating pose in which an opening of each container is aligned with a respective source or source module. Further with respect to multi-container embodiments, step 1602 may include moving the plurality of containers from the first pose to the second pose using a single actuator, for example a shared container actuator or a shared container lever.

At step 1604, an interior surface of the container may be exposed to the precursor radionuclide source. In embodiments with a plurality of containers, an interior surface of each container may be exposed to the respective precursor radionuclide source. According to some embodiments, exposing the interior surface of the container(s) to the source(s) may comprise moving the source(s) from a retracted configuration in which the source(s) is/are isolated from the container to an extended configuration in which the interior surface(s) of the container(s) is/are exposed to the precursor radionuclide source. In some such embodiments, moving the source from the retracted configuration to the extended configuration may include extending a shaft of a source module of the generator out of a sheath of the source module and through an opening of the container to expose the interior surface of the container to the source, as the source may be disposed on the shaft. In multi-source embodiments, each source may be associated with a respective shaft and/or a respective sheath of the source module, such that each shaft may be extended out of a corresponding sheath through an opening of a respective container. Extending the shaft(s) out of the sheath(s) and through the opening(s) of the container(s) may comprise forming a gas-tight seal at an interface (or at each respective interface) between the sheath(s) and the container(s) and maintaining the gas-tight seal(s) at the interface(s) while extending the shaft(s) through the opening(s). In some embodiments, exposing the interior surface(s) of the container(s) to the source(s) may further comprise coupling the source module to a housing, a source fitting or source fitting, or another portion of the generator. In multi-source embodiments, step 1604 may include moving the plurality of sources from the retracted configuration to the extended configuration using a single actuator, for example a shared source actuator or a shared source lever.

At step 1606, sufficient time may be provided to allow the precursor radionuclide source(s) to decay into at least one progeny radionuclide, and to allow the at least one progeny radionuclide to emanate from the source(s) into an interior volume of the container(s). In some embodiments, this may further include emitting a gaseous progeny radionuclide that may further decay into a solid or liquid target radionuclide disposed on an interior surface of the container(s) after an appropriate amount of time. In various embodiments, any appropriate time may be provided for the source(s) to decay and/or for the progeny to emanate therefrom, including greater than or equal to 5 hours, 10 hours, 12 hours, 20 hours, 24 hours, 36 hours, or any other appropriate time. Additionally, the time provided may be less than or equal to 120 hours, 96 hours, 72 hours, 48 hours, 36 hours, 24 hours, 12 hours, or any other appropriate time. Combinations of the foregoing are also contemplated, including, for example, greater than or equal to 5 hours and less than or equal to 120 hours, greater than or equal to 36 hours and less than or equal to 72 hours, or any other appropriate combination of the foregoing. Of course, while particular ranges for the time are provided above, it will be appreciated that other ranges both greater than and less than those noted above are also contemplated as the disclosure is not limited in this regard.

At step 1608, the precursor radionuclide source(s) may be isolated from the interior surface(s) of the container(s). In some embodiments, isolating the source(s) from the container may comprise moving the source(s) from an extended configuration to a retracted configuration, for example by retracting the shaft(s) of the source holder(s) through an opening of the container (or a respective opening of each container) and into the sheath(s) of the source holder(s), and/or by forming at least one gas-tight seal between the shaft(s) and the sheath(s) to isolate the source(s). In some embodiments, forming the at least one gas-tight seal may comprise forming a first gas-tight seal between the shaft and the sheath (or between each shaft and each sheath) on a proximal side of the precursor radionuclide source to isolate the precursor radionuclide source from the container, and forming a second gas-tight seal between the shaft and the sheath on a distal side of the precursor radionuclide source opposite the proximal side to isolate the precursor radionuclide source from a surrounding environment. In multi-source embodiments, step 160 may include moving the plurality of sources from the extended configuration to the retracted configuration using a single actuator, for example a shared source actuator or a shared source lever.

At step 1610, the container(s) may optionally be removed from the generator. In some embodiments, the container(s) may be moved from the second pose to the first pose. In other embodiments, the container(s) may be moved from the second pose to a third pose different from the first pose. Additionally or alternatively, removing the container(s) from the generator may include removing one or more loading covers from one or more loading ports of the generator to open the loading port(s), and removing the container(s) through the loading port(s).

As will be appreciated, any or all of the methods and/or method steps described herein may be performed in any appropriate manner, including the use of any appropriate automated, semi-automated, or otherwise mechanized system. Of course, it will also be appreciated that any or all of the methods and/or method steps described herein may additionally or alternatively be performed manually, as the disclosure is not limited in this regard.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

1. A method of generating a radionuclide, the method comprising:
receiving a container in a container receptacle of a radionuclide generator;
moving the container in the container receptacle from a first pose to a second pose;
exposing an interior surface of the container to a precursor radionuclide source while the container is in the second pose;
allowing sufficient time for the precursor radionuclide source to decay into one or more progeny radionuclides and to emanate the one or more progeny radionuclides into the container; and
isolating the precursor radionuclide source from the container while the container is in the first pose.

2. The method of claim 1, wherein exposing the interior surface of the container to the precursor radionuclide source comprises moving the precursor radionuclide source from a retracted configuration in which the precursor radionuclide source is isolated from the container to an extended configuration in which the interior surface of the container is exposed to the precursor radionuclide source.

3. The method of claim 2, wherein moving the precursor radionuclide source from the retracted configuration to the extended configuration comprises extending a shaft of a source module of the radionuclide generator out of a sheath of the source module and through an opening of the container to expose the interior surface of the container to the precursor radionuclide source disposed on the shaft.

4. The method of claim 3, wherein extending the shaft out of the sheath and through the opening of the container comprises extending a source holder of the shaft out of the sheath and through the opening of the container to expose the interior surface of the container to the precursor radionuclide source disposed on the source holder.

5. The method of claim 4, wherein extending the source holder out of the sheath and through the opening of the container comprises extending the precursor radionuclide source disposed in a source slot of the source holder, the source slot formed as a cavity in the source holder sized and shaped to receive the precursor radionuclide source.

6. The method of claim 5, wherein the precursor radionuclide source is formed as at least one of: a disc, an elongate disc, a tablet, a block, a chip, a sphere, a sheet, a plate, or a ball.

7. The method of claim 4, wherein extending the source holder out of the sheath and through the opening of the container comprises extending the precursor radionuclide source disposed on a source post, the source post extending from the shaft.

8. The method of claim 7, wherein the precursor radionuclide source is formed as a cylinder, and wherein at least a portion of the cylinder is an annular cylinder.

9. The method of claim 3, wherein the shaft includes a shield element disposed at a distal location relative to the precursor radionuclide source, the shield element configured to at least partially block nuclear radiation from the precursor radionuclide source from escaping the radionuclide generator.

10. The method of claim 3, wherein exposing the interior surface of the container to the precursor radionuclide source further comprises coupling the source module to a housing of the radionuclide generator.

11. The method of claim 3, wherein extending the shaft out of the sheath and through the opening of the container comprises forming a gas-tight seal at an interface between the sheath and the container and maintaining the gas-tight seal at the interface while extending the shaft through the opening.

12. The method of claim 3, wherein isolating the precursor radionuclide source from the container comprises:
moving the precursor radionuclide source from the extended configuration to the retracted configuration by retracting the shaft through the opening of the container and into the sheath; and
forming at least one gas-tight seal between the shaft and the sheath to isolate the precursor radionuclide source.

13. The method of claim 12 wherein forming the at least one gas-tight seal comprises forming a first gas-tight seal between the shaft and the sheath on a proximal side of the precursor radionuclide source to isolate the precursor radionuclide source from the container, and forming a second gas-tight seal between the shaft and the sheath on a distal side of the precursor radionuclide source opposite the proximal side to isolate the precursor radionuclide source from a surrounding environment.

14. The method of claim 1, wherein moving the container in the container receptacle from the first pose to the second pose comprises translating and/or rotating the container receptacle within the radionuclide generator to move the container from the first pose to the second pose.

15. The method of claim 1, wherein moving the container in the container receptacle from the first pose to the second pose comprises translating and/or rotating the container within the container receptacle to move the container from the first pose to the second pose.

16. The method of claim 1, further comprising moving the container in the container receptacle from the second pose to the first pose, and removing the container from the container receptacle.

17. The method of claim 16, wherein the container is a first container, the method further comprising receiving a second container in the container receptacle.

18. The method of claim 1, wherein the precursor radionuclide source comprises a thorium 228 radionuclide (²²⁸Th) radionuclide and/or a radium 224 radionuclide.

19. The method of claim 1, wherein the one or more progeny radionuclides comprises a radon 220 radionuclide (²²⁰Ra) and/or a lead 212 radionuclide (²¹²Pb).

20. The method of claim 1, wherein the precursor radionuclide source is disposed on a substrate material, the substrate material comprising at least one selected from the list consisting of: ceramic, plastic, polymer, metal, natural fiber, synthetic fiber, glass, mineral, paper, and quartz.

21. The method of claim 20, wherein the substrate material comprises quartz wool.

22. A radionuclide generator comprising:
a container module including a container receptacle configured to receive a container, the container module configured to move the container in the container receptacle between a first pose and a second pose; and
a source module configured to receive a precursor radionuclide source and configured to selectively expose an interior surface of the container to the precursor radionuclide source in an exposed configuration and isolate the interior surface of the container from the precursor radionuclide source in an isolated configuration.

23. The generator of claim 22, wherein the source module is configured to move the precursor radionuclide source between the isolated configuration and the exposed configuration.

24. The generator of claim 23, wherein the precursor radionuclide source is disposed on a shaft of the source module, the source module further comprising a sheath at least partially surrounding at least a portion of the shaft, the shaft configured to selectively extend out of the sheath through an opening of the container to expose the interior surface of the container, and retract into the sheath to isolate the interior surface of the container from the precursor radionuclide source.

25. The generator of claim 24, wherein the shaft includes a source holder configured to receive the precursor radionuclide source.

26. The generator of claim 25, wherein the source holder includes a source slot formed as a cavity in the source holder sized and shaped to receive the precursor radionuclide source.

27. The generator of claim 26, wherein the precursor radionuclide source is formed as at least one of: a disc, an elongate disc, a tablet, a block, a chip, a sphere, a sheet, a plate, or a ball.

28. The generator of claim 25, wherein the source holder comprises a source post extending from the shaft.

29. The generator of claim 28, wherein the precursor radionuclide source is formed as a cylinder, and wherein at least a portion of the cylinder is an annular cylinder.

30. The generator of claim 24, wherein the shaft includes a shield element disposed at a distal location relative to the precursor radionuclide source, the shield element configured to at least partially block nuclear radiation from the precursor radionuclide source from escaping the radionuclide generator.

31. The generator of claim 24, wherein the source module further comprises at least one seal configured to form at least one gas-tight interface between the shaft and the sheath when the shaft is retracted into the sheath to isolate the interior surface of the container from the precursor radionuclide source.

32. The generator of claim 31, wherein the at least one seal comprises a first seal and a second seal disposed on the shaft, the first seal disposed on a proximal side of the precursor radionuclide source and configured to isolate the precursor radionuclide source from the container, the second seal disposed on a distal side of the precursor radionuclide source opposite the proximal side and configured to isolate the precursor radionuclide source from a surrounding environment.

33. The generator of claim 24, further comprising a housing at least partially surrounding the container module, the housing configured to removably receive the source module and configured to align the shaft with an opening of the container when the container is in the second pose.

34. The generator of claim 22, further comprising a housing at least partially surrounding the container module, the housing configured to removably receive the source module.

35. The generator of claim 22, wherein the source module comprises a seal configured to form a gas-tight interface between the source module and the container when the interior surface of the container is exposed to the precursor radionuclide source.

36. The generator of claim 22, wherein the container module is configured to move the container in the container receptacle between the first pose and the second pose by translating and/or rotating the container receptacle within the radionuclide generator.

37. The generator of claim 36, wherein the container module comprises a first lever operably connected to the container receptacle to rotate the container receptacle about a lever axis between the first pose and the second pose.

38. The generator of claim 36, wherein the container module comprises a container drive assembly selectively engageable with the container receptacle, the container drive assembly configured to selectively translate the container receptacle in at least one linear direction.

39. The generator of claim 38, wherein the container module comprises a second lever operably connected to the linear actuator to selectively engage or disengage the container drive assembly and the container receptacle.

40. The generator of claim 38, wherein the container module includes a removable container fitting configured to be selectively inserted into and removed from the container receptacle, the container fitting sized and shaped to receive the container, the container receptacle sized and shaped to selectively receive the container fitting.

41. The generator of claim 22, further comprising the precursor radionuclide source.

42. The generator of claim 41, wherein the precursor radionuclide source comprises a thorium 228 radionuclide (²²⁸Th) radionuclide and/or a radium 224 radionuclide.

43. The generator of claim 41, wherein the precursor radionuclide source is configured to emanate one or more progeny radionuclides comprising a radon 220 radionuclide (²²⁰Ra) and/or a lead 212 radionuclide (²¹²Pb).

44. The generator of claim 41, wherein the precursor radionuclide source is disposed on a substrate material, the substrate material comprising at least one of: ceramic, plastic, polymer, metal, natural fiber, synthetic fiber, glass, mineral, paper, and quartz.

45. The generator of claim 44, wherein the substrate material comprises quartz wool.
